(19) United States
(12) Patent Application Publication
(10) Pub. No.: US 2013/0089026 A1
(43) Pub. Date: Apr. 11, 2013

(54) Wireless Audio Transmission

(71) Applicants: geoffrey Chilton Piper, San Francisco, CA (US); James Henry Lynch, III, San Francisco, CA (US); Thomas Richard Murphy, San Francisco, CA (US); Scott Carter Bittle, Redwood City, CA (US); Steven Geroge Christensen, State College, PA (US); Neal Breitbarth, San Francisco, CA (US); Nicholas Porcaro, Brooklyn, NY (US)

(72) Inventors: geoffrey Chilton Piper, San Francisco, CA (US); James Henry Lynch, III, San Francisco, CA (US); Thomas Richard Murphy, San Francisco, CA (US); Scott Carter Bittle, Redwood City, CA (US); Steven Geroge Christensen, State College, PA (US); Neal Breitbarth, San Francisco, CA (US); Nicholas Porcaro, Brooklyn, NY (US)

(21) Appl. No.: 13/551,370

(22) Filed: Jul. 17, 2012

Related U.S. Application Data
(60) Provisional application No. 61/509,077, filed on Jul. 18, 2011.

(51) Int. Cl. H04W 4/00

(52) U.S. Cl. CPC H04W 4/00
USPC 370/328

(57) ABSTRACT

Approaches for the wireless transmission of audio data are provided, wherein an example approach operates to convert live audio signals, from instruments, microphones, amplifiers, mixers, speakers, MIDI devices, and other similar devices, into wireless signals by utilizing electrical plug devices (“jacks”), whereby the jacks transmit multiple channels of audio/video signals via a standard wireless network to a software application running on a host recording device on the same network.

### CLAIM OF PRIORITY

This application claims priority to U.S. provisional patent application No. 61/509,077, filed Jul. 18, 2011, entitled “Wireless Networking Jacks and a Mobile Recording Studio,” the contents of which are hereby incorporated by reference for all purposes as if fully set forth herein.

### BACKGROUND

Live performances are often recorded using a complex and expensive setup of audio/video equipment and gear with an even more complex and confusing interwoven set of connections, cables and wires. Recording, mixing and mastering in studios requires large amounts of physical space, is often not flexible, is expensive and requires additional personnel. Distributing recordings takes a long period of time, from making the recordings through the mixing and mastering processes, to then creating digital or physical media of such mixed and mastered recordings to be ready for distribution to people through third-party channels.

### SUMMARY

This specification describes technologies relating generally to wireless audio and video transmission, capture, management, presentation, distribution and recording.

In general, one aspect of the subject matter described in this specification can be embodied in a method that includes receiving multiple channels of audio signal data generated by multiple performers at multiple audio transceiver devices (wireless jacks). In an embodiment, each device is connected to a single source (e.g., performer, instrument, device, etc.) and receiving audio from that source. The audio transceiver devices have wireless transmission capabilities for sending and/or receiving the audio signals over a wireless connection. The audio transceiver devices connect to a wireless network, which in an embodiment is a wireless network defined by an ubiquitous standard like 802.11 or any succeeding standard, and the wireless network is in one embodiment created or initiated by one, perhaps more, of the audio transceiver devices. The audio signals are transmitted from the audio transceiver devices over the wireless network to a single host device that is alos connected to the wireless network. In an embodiment, multiple channels of audio signal data are transmitted over a single wireless channel.

In general, one aspect of the subject matter described in this specification can be embodied in a system that comprises at least one audio transceiver device that is configured to received audio signals from a source, such as an instrument, to which it is communicatively coupled. A host device is provided that is configured to receive the audio signal data from the at least one audio transceiver device. A wireless network is provided, over which the at least one audio transceiver device and host device have capability to send and/or receive audio signals, in digital or analog form, over the wireless network. The wireless network is created and/or initiated by the at least one audio transceiver device.

In general, one aspect of the subject matter described in this specification can be embodied in a device, such as a wireless jack device, that includes an input module for receiving audio signals from a source to which the device is communicatively coupled, such as an instrument. Also provided is a networking module for creating and/or initiating a wireless network and/or wireless network connection and for receiving and transmitting audio signals (digital or analog) over the wireless network. Also provided is a processing module for executing one or more sequences of instructions stored in a memory module, the instructions which when executed by the processing module, causes the access of configuration data that describes and/or contains parameters of a wireless network, e.g., a default wireless network and also causes the creation of and/or joining to a wireless network based on the parameters described by the configuration data. Further, in response to receiving instructions from a host device, the device receives the audio signals from the source and transmits the audio signals over the wireless network to the host device.

Some embodiments include systems, apparatuses, processes and methods for capturing live audio signals (from instruments, microphones, amplifiers, MIDI connected devices, and other similar devices), recording, processing, editing, listening to and distributing recordings of live performances or live events, including audio and video of such events, while the event is still occurring or at a later time, and distributing to those nearby or via the Internet. Embodiments use electrical jack devices that emit wireless signals through a private WiFi network to a host recording device (such as personal computers, netbooks, tablets (e.g., iPads), mobile phones (e.g., iPhones) or other wireless devices (e.g., iPods and MP3players) where such signals are captured as multiple wireless signals in a single host recording device, and such host recording device then is capable of processing the signals together and distributing the processed recordings in real time to performers, other nearby listeners, and via the Internet.

Implementations may include one or more of the following features. Embodiments capture live audio signals (from instruments, microphones, amplifiers, MIDI connected devices, and other similar devices), recording, processing, editing, listening to and distributing recordings of live performances or live events, including audio and video of such events, while the event is still occurring or at a later time, and distributing to those nearby or via the Internet. Such embodiments use electrical jack devices that emit wireless signals through a wireless network to a host device (such as personal computers, netbooks, tablets (e.g., iPads), mobile phones (e.g., iPhones) or other wireless devices (e.g., iPods and MP3players) where such signals are captured as multiple wireless signals in a single host device, and such host device then is capable of processing the signals together and distributing the processed recordings in real time to performers, other nearby listeners, and via the Internet.

Implementations may include one or more of the following features. Embodiments capture an instrument's, microphone's or amplifier's audio signal (by means of standard connection technology built into every instrument, microphone and amplifier that would be familiar to one of ordinary skill in the art), or a MIDI signal, and streams that signal wirelessly over a wireless network to software running on a host device on the same network.

Implementations may include one or more of the following features. Embodiments are programmed to simultaneously create or connect to a common and shared wireless network of other like connected hardware and the host device. The network is used by the embodiments and host device to move audio content wirelessly, emitted from the embodiments to the host device. The embodiments uses audio frequency processing logic (e.g., chipsets) with custom firmware programmed for networks with security keys according to standards that would be familiar to one of ordinary skill in the art.

Implementations may include one or more of the following features. Embodiments enable a single performer with a single piece of embodiments to create a network and connect with the host device, or the network enables multiple performers with multiple pieces of embodiments to create a network and connect with the host device.

Implementations may include one or more of the following features. Embodiments contain a pass-through signal apparatus to enable signals to be transmitted to external amplification sources and speaker systems. The performers use the pass-through apparatus to transmit instrument, microphone, amplifier or MIDI signals to an external device (such as an additional amplifier or mixing console) to be further amplified or broadcast for real-time listening of the performance. The pass-through signal apparatus interoperates with standard MIDI, instrument and microphone cable connections and sizes according to standards that would be familiar to one of ordinary skill in the art. The pass-through mechanism allows a performer to use the electrical jack device simultaneously to send wireless signals to a host device, while still sending a traditional analog signal via cabling to an external amplifier, mixing console or other device.

Implementations may include one or more of the following features. Embodiments may be battery powered and turned on by a push button. LEDs on the hardware surface identify hardware power status, network status, and software host connection. Embodiments allow firmware programming to support cutting power to the hardware's audio logic (e.g., a chipset) if no host software is present on the network to extend battery life according to standards that would be familiar to one of ordinary skill in the art.

Implementations may include one or more of the following features. Embodiments allow a performer to push a button and reset the electrical jack device for the purpose of restoring default network settings to the electrical jack device. Embodiments can be used by performers in group settings on the same network, and alone on the same network. The reset button allows performers to disassociate from the currently connected network so that at a later time the performer can use the same electrical jack device to join the same or a new network depending on the performer's needs.

Implementations may include one or more of the following features. Embodiments enable the host recording device on the wireless network to specify new settings for SSID (network name), security key, and whether or not the SSID is public, and to write these settings over the wireless network to any electrical jack device.

Implementations may include one or more of the following features. Embodiments enable the software to run on multiple platforms and multiple operating systems and function as a digital audio workstation software application running on a host device that receives multiple wireless signals and routes the signals to recording channels within the software already installed on the host device.

Implementations may include one or more of the following features. Embodiments organize wireless signals, apply processing, and simultaneously send the processed signals back to the performers for real-time monitoring to hear the performance as it is performed. The software routes the processed signals via the host device's built-in output system to an external device (such as headphones and a headphone mixing device) by using a cable connection, or via the host device's built-in wireless technology to an external device (such as headphones and a headphone mixing device).

Implementations may include one or more of the following features. Embodiments allow users to listen to recordings after being captured, apply further processing, and export the recordings for use in other devices (such as personal computers or other mixing consoles and devices) or software applications, or to distribute the recordings via the Internet or other similar digital and physical media.

Implementations may include one or more of the following features. Embodiments allow users of the software to connect to third-party hosted servers for storage of such recordings and additional processing and editing at later times.

Implementations may include one or more of the following features. Embodiments interoperate with a host device's video technology to enable users of the host device to combine recordings captured by the software with live real-time video of the performers captured by the host device. The video signal is organized as a separate channel within the recording software and the recording software then processes the combined signals, and simultaneously sends back processed signals to performers for real-time monitoring and hearing the performance as it is performed wirelessly to a connected audiovisual device (such as a personal computer, a television, or other video monitor). Any available second network connection on or for the host device (in addition to the wireless network receiving audio) may be used to broadcast the mixed audio/video signals over the public internet.

Implementations may include one or more of the following features. Embodiments allow remote control of the software application to control aspects of the recording process at a distance and during or after performances and recordings. The remote control software syncs with the software application running on the host device to enable the controls.

Implementations may include one or more of the following features. Embodiments connect to the host recording device to receive processed signals from the host recording device either wirelessly, or by means of a connecting cable to the host recording device's standard output jack located on the host recording device. This hardware of an embodiment splits the signal into multiple signals, which may then be simultaneously outputted to a group of connected headphones wirelessly or by means of cable connections to headphones. The performers monitor playback of their performance via headphones wirelessly or via cabling connections.

These and other aspects as described herein may be implemented as methods, processes, systems, devices, apparatuses, computer program products, or otherwise. Some aspects may include and/or utilize instructions tangibly stored on a computer readable medium and/or instructions tangibly encoded in digital logic. Such instructions may be operable to cause a wireless audio transceiver device to perform the operations and/or functionality described. Wireless audio transceiver devices may include digital logic circuitry, digital microcontrollers and/or programmable processors. Some wireless audio transceivers may run on software, while others may operate independent of software.

The details of one or more implementations are set forth in the accompanying drawings and the description below. Other features will be apparent from the description and drawings, and from the claims.

### BRIEF DESCRIPTION OF THE DRAWINGS

Some embodiments are illustrated by way of example and not limitation in the figures of the accompanying drawings, and in which like reference numerals refer to similar elements, and in which:

FIG. 1 is a diagram of the internal components of an example electrical instrument “jack” device;

FIG. 2 is a depiction of the external components of an example embodiment of a wireless jack device, according to an embodiment;

FIG. 3 is a depiction of an embodiment of jack device 100 that comprises a portable, battery powered, electrical microphone jack device 302 that operates with microphones, according to an embodiment;

FIG. 4 is a flow chart showing an example process 400 for using a jack device, according to an embodiment;

FIG. 5 is a flow chart showing an example process 500 for using a software application for connecting a network of jack devices, according to an embodiment;

FIG. 6 is a flowchart showing an example process 600 for using a software application in combination with a computer and jack devices to capture simultaneous live signals, according to an embodiment;

FIG. 7 is a depiction of an example wireless headphone monitoring and mixer device, according to an embodiment;

FIG. 8 is a flowchart showing an example process 800 for using a wireless audio driver interface in combination with wireless jack devices to capture simultaneous live signals, according to an embodiment;

FIG. 9A is a flowchart showing an example process 900 for using data in order to take a particular action, according to an embodiment;

FIG. 9B is a flowchart showing an example matrix 950, according to an embodiment;

FIG. 10A is a depiction of an example display 1000 of user interface elements generated by an example embodiment;

FIG. 10B is a flowchart showing an example process 1050 for providing user interface elements, according to an embodiment;

FIG. 11 is a depiction of an example environment for which the heartbeat synchronization embodiments may be utilized;

FIG. 12 is a flowchart showing an example process 1200 for synchronizing wireless audio data, according to an embodiment; and

FIG. 13 is a block diagram that illustrates an example computer system upon which example embodiments may be implemented.

### DETAILED DESCRIPTION

Approaches for the wireless transmission, capture, management, presentation, distribution and recording of live performances are presented herein. In the following description, for the purposes of explanation, numerous specific details are set forth in order to provide a thorough understanding of the embodiments described herein. It will be apparent, however, that the embodiments described herein may be practiced without these specific details. In other instances, well-known structures and devices are shown in block diagram form or discussed at a high level in order to avoid unnecessarily obscuring teachings of embodiments.

### Overview

Performers trying to record audio and/or video in live performance settings, whether that setting is as intimate as a single room or as expansive as a concert hall, face a similar set of difficulties. Current approaches require a multitude of equipment in order to capture, transmit and record live audio and/or video. For example, in order to record two performers, one on guitar and one on vocals, the setup may require the guitar and microphone to be connected via wires to a mixing apparatus, then the mixing apparatus be wired to an intermediary recording device (e.g., a Pro Tools analog-to-digital audio interface, or “box”, which itself is connected to a computer with mouse, keyboard, and monitor screen), that recording device also connected to a mixing apparatus, all while the performers are wearing monitoring devices (usually connected via wires) to hear their performance as it is being recorded and as effects are being applied (perhaps via another device). If the number of performers is increased, the need for costly, large, complex equipment increases accordingly.

This multitude of equipment and wires presents an impediment to musicians who wish to quickly pick up their instruments and record a jam session. Example approaches described herein operate to convert live audio signals, from instruments, microphones, amplifiers, mixers, speakers, MIDI devices, and other similar devices, into wireless signals by utilizing electrical plug devices (“jacks”) whereby the jacks transmit audio/video signals via a wireless network to a software application running on a host recording device on the same network. According to an embodiment, multiple audio channels are sent per WiFi wireless channel or on a single WiFi wireless channel.

According to an example embodiment, multiple live audio signals are converted by the jacks and transmitted wirelessly to a host device that may operate to record the signals synchronized in time. Host devices may include mobile phones, tablets, laptop and personal computers (including desktops, laptops, netbooks and ultrabooks) of varying operating systems. The audio signals are then organized within a software application which may be executing on the host device for the purpose of recording the signals while, according to example embodiments, simultaneously applying effects processing to the signals and re-sending the effected signals back wirelessly to the performers for real-time monitoring and listening of the actual performance being played via a variety of devices including speakers, a wireless headphone mixer and wireless headphones. Further, the software application or another component may operate to allow the recorded signals to be edited later with additional effects processing, whether on the host device or another device, and listened to by means of speakers, a wireless headphone mixer device and wireless headphones at later times, or exported (e.g., as a digital file) for use within other software applications and devices (such as a personal computer), or immediately distributed via the Internet or other media.

Example embodiments provide hardware and/or software approaches to solve the above-referenced recording, synchronizing, mixing, mastering and distribution problems by making these processes wireless, Internet-connected, mobile and more collaborative. This allows performers to produce content faster, more efficiently, more cost effectively and with few sacrifices on quality. Performers using the example techniques described herein will be better able to perform, collaborate and record wirelessly in real time via a centralized device but with all of the benefits of a standard multi-track recording session. Example embodiments replace a more traditional mixing console, physical studio space and constraints of wires.

The techniques described herein may operate similarly to convert live video signals of live performance events, transmit such wireless signals over a wireless network to a software application running on a host device on the wireless network, and provide for the synchronization and manipulation of the captured video for various distribution methods.

For purposes of this specification, the techniques described as they relate to audio may also apply to video, as well as a combination of both; therefore, while audio will be primarily discussed with regard to the present disclosure, it should be understood that the same techniques are envisioned as being applicable to audio, video and/or a combination of the two, and there is no intent to limit the scope of this application as only applying to either audio or video.

### Wireless Networking Jack Devices

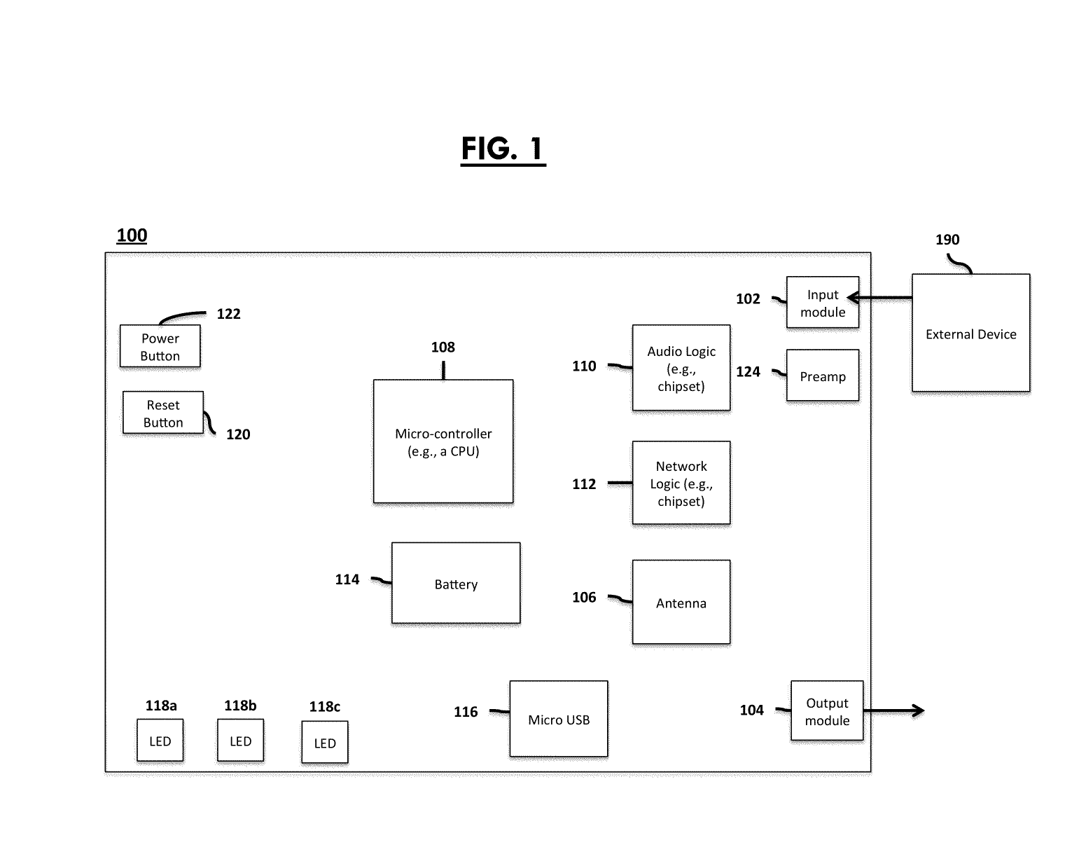

FIG. 1 is a depiction of the internal components of an example electrical instrument “jack” device 100. According to an embodiment, jack device 100 is comprised of various modules programmed to perform various tasks. These modules may be implemented in hardware or software and may comprise internal connections (not shown in FIG. 1) allowing the various modules to be communicatively coupled in any desired configuration, as well as allowing one or more modules to be communicatively coupled to external devices. Additional modules not explicitly shown in FIG. 1 may also be included in jack device 100 in other implementations, and modules and/or their functionality may be combined or divided into further modules in certain embodiments.

According to an example embodiment, jack device 100 is adapted to be affixed to instruments, microphones, amplifiers, mixers and MIDI devices, for example via such instrument's, microphone's, amplifier's, mixer's or MIDI device's onboard electrical jack transmitting socket, during use of the instrument, microphone, amplifier, mixer or MIDI device.

In the example embodiment of FIG. 1, jack device 100 comprises an input module 102 that operates to receive audio signals from an external source 190; e.g., an instrument, microphone, amplifier, mixer or MIDI device. Signals (e.g., analog or digital signals comprising audio data) may be output from jack device 100 wirelessly or via a physical connection in mono and/or stereo. An output module 104 is provided to allow a signal to be outputted from the jack device 100 and be carried from jack device 100 to external devices, such as additional amplification systems and sets of speakers, mixing consoles or other devices. For example, an embodiment of such output mechanism involves receiving analog signals through input module 102, routing such signals to audio logic module 110 and the processing module 108, for conversion to digital and back to analog, to then in turn be routed to the output module 104. Additionally, a wireless module 112 (including its related antenna 106) is provided for outputting and inputting signals wirelessly via a wireless network. In an embodiment, the wireless network is a standard 802.11 WiFi network that carries digital data packets rather than a wireless network that carries analog audio signals. As succeeding wireless networking standards are envisioned, embodiments are intended to operate with ubiquitous standards adopted for wireless networking, now existing or adopted in the future. No custom wireless standard or protocol is required for example embodiments to operate. In an embodiment, jack device 100 provides three output modules 104, 106 and 116 to allow the performer flexibility to simultaneously deliver a mono or stereo signal to a host device nearby as a wireless signal, and an additional external amplifiers and speaker systems so that the performer can also deliver the signal as live sound for an audience and another device (such as a personal computer).

Jack device 100 comprises a processing module 108 that, in an embodiment, provides audio and control processing capability for jack device 100. Processing module 108 may comprise a CPU capable of receiving and executing sequences of instructions; for example, user commands (such as power and reset) and functions internal to jack device 100. In an embodiment, processing module 108 is the “central hub” inside jack device 100 and routes converted signals to the network logic module 112. Processing module 108 may also consist of an Application Specific Integrated Circuit (ASIC) and/or Field Programmable Gate Array (FPGA) chip into which is downloaded a custom digital circuit. Processing module 108 may consist of any combination of the above mentioned elements, as each may handle different aspects of the tasks required. Processing module 108 is the central hub and routing “patchbay” between network logic module 112, bus module 116 and the audio logic 110 and therefore processing module 108 can route audio or control data, or both, in any direction between any of these three external connections.

An audio logic module 110 is provided that, in an embodiment, provides the capability for (i) performing analog to digital conversion of incoming audio signals, (ii) streaming analog audio signals to an external device (e.g., a host recording device) and (iii) receiving commands related to audio processing. In an example, commands may be received from users of a software application running on a host recording device. These commands can be used to change system control parameters such as the sampling rate, audio bit rate, number of channels, device name identifier, model number, firmware version number, wireless network type/speed, wireless network signal strength, transmission protocol, battery charge status, and other system control parameters.

In an embodiment, audio logic module 110 further comprises a PLL chipset or similar functionality, as will be described more fully herein. In example embodiments, the PLL functionality as described further herein may be incorporated into one or more existing modules as described with regard to FIG. 1, or may be embodied in a separate module or modules based in hardware, software and/or firmware.

A network logic module 112 is provided that, in an embodiment, provides the capability for configuring, creating and connecting to a wireless network and for broadcasting and receiving wireless signals, in one embodiment using standard wireless networking protocols known in the art (e.g., 802.11). Jack device 100 may be powered by an internal battery 114 or via an external power source. Battery 114 may be of a rechargeable nature (e.g., lithium-ion), in which case battery 114 is coupled to a bus module 116 or other means for connection to an external power source. Bus module 116 may comprise a USB architecture or any other bus technology known in the art. Bus module 116 in one embodiment comprises a micro-USB architecture and may be used to connect to an external source for recharging battery 114 as well as receiving and sending audio signals and control commands related to jack maintenance, updates, data transfer and related processes and procedures. In an embodiment, jack device 100 supports reducing or cutting power to the internal modules (e.g., internal chipsets) if no wireless network is present or jack device 100 is not connected to software on a host recording device.

One or more modules may comprise a memory module capable of storing information such as sequences of instructions (e.g., software). These memory modules may be incorporated into existing modules or be implemented as stand-alone hardware modules. These memory modules may be implemented in volatile or non-volatile memory and may comprise firmware. The modules described herein may store, process and retrieve instructions and/or information in memory structures to which the modules have access. For example, one module may perform an operation pursuant to instructions stored in a memory module and store the output of that operation in a memory module to which it is communicatively coupled. A further hardware module may then, at a later time, access the memory module to retrieve and process the stored output.

In an embodiment, internal connectors are provided for coupling to, and in some examples providing power to, external user interface elements. For example, jack device 100 may comprise one or more light-emitting diode (LED) connections 118a-118c, as well as other interfaces (including LCD panels and other graphical displays) to external control elements such as a power button module 122 and a reset button module 120. In an example embodiment, power button module 122 and reset button module 120 do not comprise actual interface elements (e.g., buttons), but merely provide a coupling that receives input from an external interface element (such as a power or reset button on the exterior of jack device 100).

An audio preamp module 124 is provided that, in an embodiment, gain-optimizes incoming analog audio signals received through input module 102 from external device 190.

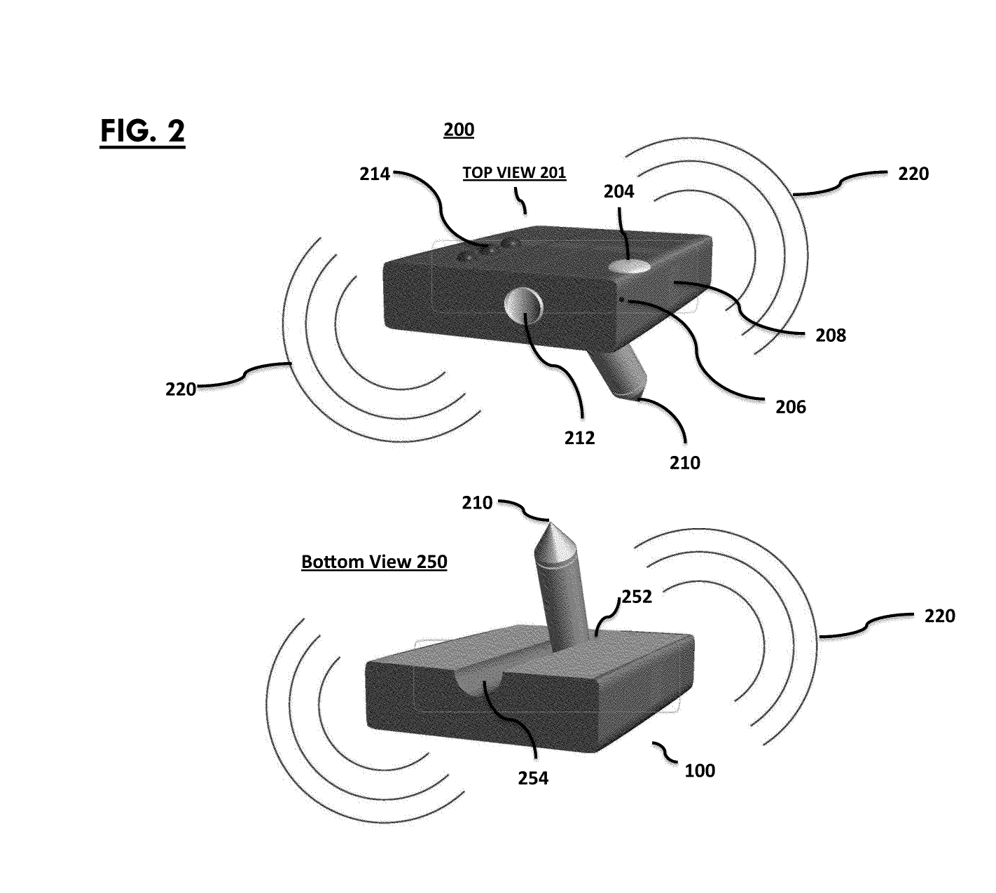

FIG. 2 is a depiction of the external components of an example embodiment of jack device 100. Jack device 200 in an embodiment comprises a portable, battery powered, electrical instrument interface device 200 designed for operation with instruments and amplifiers (among other devices) that receives analog audio signals by connecting with an instrument's or amplifier's jack plug socket, or, by reversing the signal path, taking an instrument's analog signal from a standard one-quarter (¼) inch instrument cable, plugged into the female ¼ inch jack on jack device 200, and using the male plug to pass the signal through to an amplifier. Jack device 200 is in one embodiment designed to be small and lightweight in order to be unobtrusive during performance and to affix easily to the instrument's or amplifier's jack plug socket without falling out or being dislodged while in use. Jack device 200 may be small enough to be carried in a performer's pocket. In an embodiment, jack device 200 connects to and communicates audio signal data via a wireless network 220.

In an example embodiment, jack device 200 can be inserted into any standard ¼ inch female jack plug socket (such as an amplifier send jack) so that a user can send a wireless signal from an amplifier to a host device (instead of from an instrument or microphone) if the user so chooses to do so. The aspects of embodiments of jack device 200 described herein apply similarly for a user who decides to use jack device 200 with an amplifier instead of an instrument. It should be understood that alternate designs of jack device 200 may comprise identical functionality, as well as being capable of connecting to a variety of devices and using cabling connection sizes and standards that would be well familiar to one of ordinary skill in the art.

Turning to the top view 201 of the exterior of jack device 200, in an example embodiment there is provided a power button 204 and a reset button 206, both of which may be communicatively coupled to power button module 122 and reset button module 120 from FIG. 1. While the example of FIG. 2 describes these interface elements as a “power button” and “reset button,” respectively, in alternate embodiments the buttons may be combined or operate to perform different functions entirely. For example, reset button 206 may operate to reset certain states and/or memory settings of jack device 200, such as default network settings.

One or more external connection ports 208 are provided that, in one embodiment, comprises a micro-USB interface that is communicatively coupled to bus module 116 in FIG. 1. External connection ports 208 may be covered with a flap or otherwise protected while not in use. The jack device 200 plug 210 is in one embodiment designed as a male jack plug (¼ inch sized) for inserting within any standard ¼ inch female jack plug socket according to standards that would be well familiar to one of ordinary skill in the art. This receiving socket may be located directly on an instrument or an amplifier's send output.

A pass-through electrical instrument port 212 may be provided that is communicatively coupled to output module 104 as shown in FIG. 1. According to an example embodiment, pass-through electrical instrument port 212 operates to receive an instrument's analog signals. Pass-through electrical instrument port 212, in conjunction with output module 104, sends the signal directly through jack device 200 unaltered (according to standards that would be well familiar to one of ordinary skill in the art) so that a performer may send the signal via standard ¼ inch coaxial cabling to an external amplification unit and speaker system for live sound purposes to deliver such sound to an audience.

Light-emitting diodes (LEDs) 214 may be provided which, in an example embodiment, operate to inform the user, among other things: (1) jack device 200 has power; (2) network status (i.e., jack device 200 is or is not connected to a network 220 which may be wireless and comprise other electrical jack devices); and (3) software connection (i.e., jack device 200 has connected to recording software running on a host device).

Turning to the bottom view 250 of the exterior of jack device 200 according to an embodiment, plug 210 is designed for ball and socket rotation 252 in order to bend at desired angles, as necessary to connect to varying insertion angles of female jack plug sockets across instruments, amplifiers and varied designs. In an embodiment, plug 210 also pivots to be stowed within a recess 254 on the bottom side of jack device 200 so that plug 210 is out of sight and protected when not in use. Plug 210 in one embodiment is designed to insert into an instrument's or amplifier's jack plug socket to receive analog signals and inputs from the instrument or amplifier.

In an example embodiment, an additional ¼ inch female receiving socket (not pictured in FIG. 2) may be provided as an alternative input mechanism. This would allow a performer to run a ¼ inch wire run from an instrument into the additional ¼ inch female receiving socket, after which jack device 200 may be mounted on the performer or her instrument. In an embodiment, this additional ¼ inch female receiving socket would allow similar functionality to plug 210 designed for ball and socket rotation 252 where form factor constraints may not allow for plug 210.

In an example embodiment, jack device 200 comprises a portable, battery powered, electrical MIDI jack device designed specifically for operation with any device that outputs MIDI data by connecting with the device's MIDI plug socket. Such electrical MIDI jack device has essentially the same mechanisms and features of jack device 200 herein, but is designed to connect with and interoperate with MIDI devices and MIDI connection cabling sizes and standards that would be well familiar to one of ordinary skill in the art. As with jack device 200, an electrical MIDI jack device plug may be designed as a male jack plug to be inserted into a female socket on a host MIDI device, or with an additional female receiving input mechanism, with a pass-through female socket on the other side to be used for pass-through signals. A pass-through MIDI jack mechanism allows other devices to be attached to the MIDI signal chain. The pass-through MIDI jack mechanism sends the signal directly through the electrical MIDI jack device unaltered so that the performer may send the signal via standard MIDI cabling to another MIDI device.

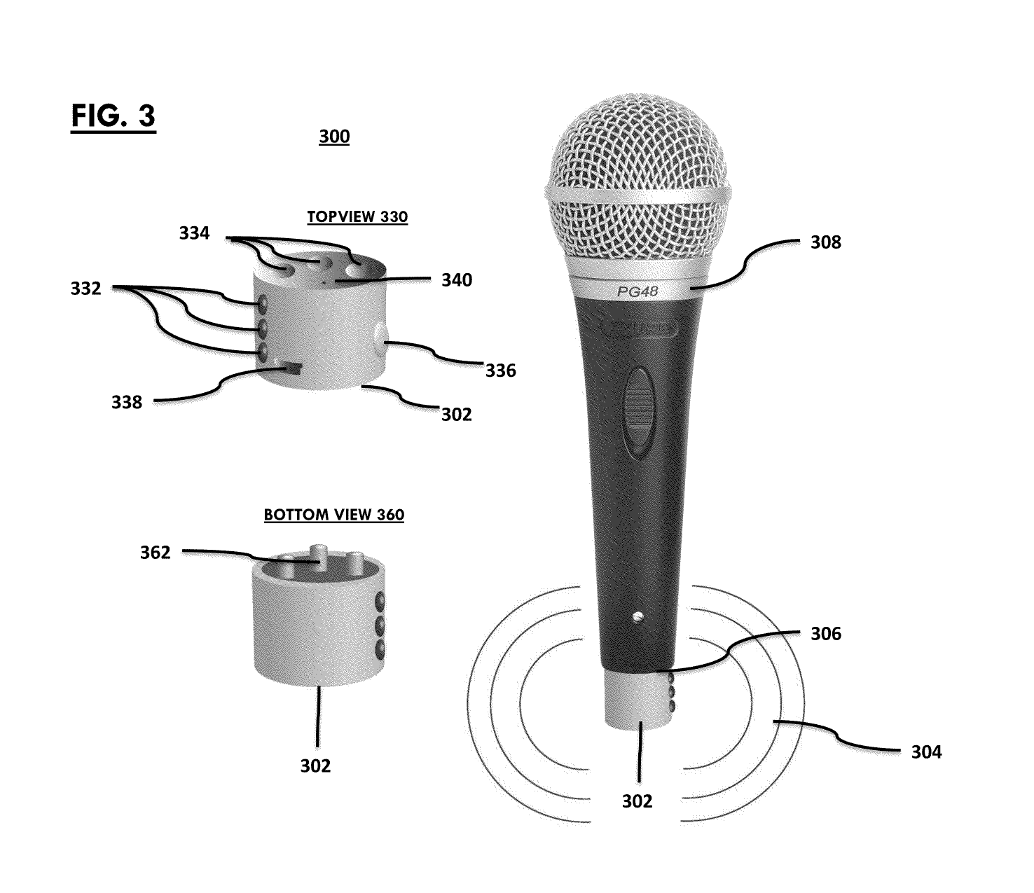

FIG. 3 is a depiction of an embodiment of jack device 100 that comprises a portable, battery powered, electrical microphone jack device 302 that operates with microphones. In an embodiment, microphone jack device 302 is functionally similar to the jack device 100 as embodied in FIGS. 1 and 2, while in alternate embodiments the internal modules of microphone jack device 302 may comprise different or modified components over that described with regard to FIG. 1.

Microphone jack device 302 receives analog audio signals by connecting with a jack plug socket 306 (not pictured) of a microphone 308. The details of the connection may be seen more clearly in the top view 330 of FIG. 3, where the female plug receptacles 334 that connect with the male end connectors of microphone 308 are illustrated. In alternate embodiments, a male plug may be substituted for a female plug and vice versa without affecting the functionality of microphone jack device 302. The female plug receptacles 334 are designed as a female jack plug (to receive traditional XLR male end connectors and according to standards that would be well familiar to one of ordinary skill in the art) on the top of microphone jack device 302. The female plug receptacles 334 are designed to fit flush with the microphone chassis 308 with no space between the bottom of the microphone and microphone jack device 302. Microphone jack device 302 inserts into the microphone's bottom jack plug socket 306 to receive all three male plugs, and to then receive analog signals and inputs from the microphone.

Turning to the top view 330 of microphone jack device 302, in an example embodiment there is provided a power button 336 and a reset button 340, both of which may be communicatively coupled to power button module 122 and reset button module 120 from FIG. 1. While the example of FIG. 3 describes these interface elements as a “power button” and “reset button,” respectively, in alternate embodiments the buttons may be combined or operate to perform different functions entirely. For example, reset button 340 may operate to reset certain states and/or memory settings of microphone jack device 302, such as default network settings. In an embodiment, reset button 340 is recessed within the body of microphone jack device 302 so that when microphone jack device 302 is connected to a microphone 308, reset button 340 is not depressed by the action of connecting and pressing against the body of the microphone.

Light-emitting diodes (LEDs) 332 may be provided which, in an example embodiment, operate to inform the user, among other things: (1) the microphone jack device 302 has power; (2) network status (i.e., microphone jack device 302 is or is not connected to a network 304 which may comprise other electrical jack devices); and (3) software connection (i.e., the electrical instrument jack device has connected to recording software running on a host device and may be changed during recordings sessions to indicate status). One or more external connection ports 338 are provided that, in one embodiment, comprises a micro-USB interface that is communicatively coupled to bus module 116 in FIG. 1. External connection ports 338 may be covered with a flap or otherwise protected while not in use. In an embodiment, microphone jack device 302 is powered by a rechargeable (e.g., a lithium-ion battery) battery, which in an embodiment may be recharged by connecting to an external device through a micro-USB interface via the external connection ports 338.

Turning to the bottom view 360 of microphone jack device 302, in an example embodiment there is provided a pass-through electrical instrument port 362 that is communicatively coupled to pass-through output module 104 as shown in FIG. 1. According to an example embodiment, pass-through electrical instrument port 362 operates to receive an instrument's analog signals. Pass-through electrical instrument port 362, in conjunction with output module 104, sends the signal directly through jack device 100 unaltered (according to standards that would be well familiar to one of ordinary skill in the art) so that a performer may send the signal via standard XLR cabling to an external amplification units, mixers and speaker systems for live sound purposes to deliver such sound to an audience.

An embodiment of microphone jack device 302 is small and lightweight in order for microphone jack device 302 to be unobtrusive during performance and to affix to a microphone 308 without falling out or easily being dislodged while being used. Microphone jack device 302 is small enough to be carried in a performer's pocket, may be cylindrical in shape and fits snugly to the bottom of a microphone 308 so as not to add too much additional length to the microphone 308. It should be understood that microphone jack device 302 may be adapted to operate with any number of microphones and their connection types, according to standards to fit each microphone type that would be well-familiar to one of ordinary skill in the art.

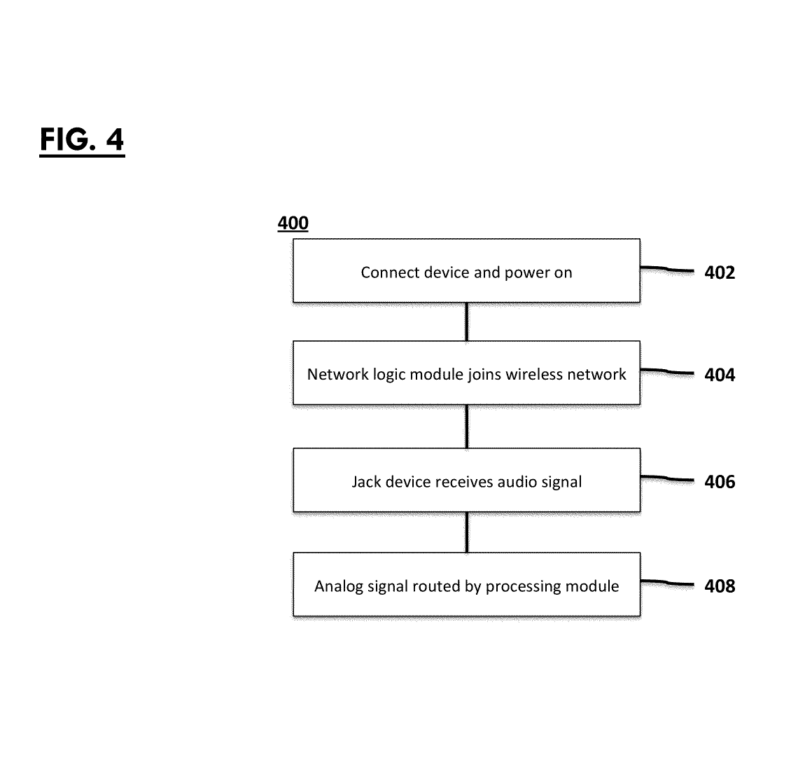

FIG. 4 is a flow chart showing an example process 400 for using a jack device 100 according to an embodiment. The process 400 can be implemented by the jack device 100 of FIG. 1, as implemented by the instrument jack device of FIG. 2, the MIDI jack device as discussed herein, the microphone jack device 302 of FIG. 3 or by a different device or system. In some implementations, the process 400 can include fewer, additional and/or different operations. In other examples, only one or some subset of these operations may be included, as each operation may stand alone, or may be provided in some different order other than that shown in FIG. 4. For clarity, the general jack device 100 of FIG. 1 will be referred to with regard to the description of FIG. 4, but it should be understood that the example embodiments described herein are not so limited.

At 402, jack device 100 is connected to an instrument, such as a guitar or microphone, a MIDI device or similar device, and powered on, for example by depressing the power button as previously described.

At 404, the network logic module 112 creates or joins a wireless network. The wireless network may be comprised of other jack devices 100. In an embodiment, the network logic module 112 connects wirelessly to a software application executing on, for example, a host device, which has joined the same wireless network as the jack devices, and receives a heartbeat pulse for the purpose of synchronizing the jack internal sample rate mechanism as described herein and further below. LED indicator lights may be activated as a method of providing a user interface to a user reflecting the status of various parameters associated with jack device 100, such as power, network connection status, and connection status to a host device. The wireless network created or joined by the network logic module 112 facilitates the transmission of radio frequency wireless signals by the audio logic module 110 of the jack device 100 to a software application running on a host device.

At 406, jack device 100 receives an analog audio signal (e.g., created by a performer using an instrument, microphone or amplifier) through, for example, the jack device plug 210 of the jack device 100, which then delivers the signal through a metal shaft of the plug into the body of the jack device 100. According to another embodiment, the analog signal is received from the tips of the male XLR plugs of the microphone 308, which are then delivered to the microphone jack device 302 through three female XLR receiver sockets, into the body of the microphone jack device 302.

At 408, the analog signal is routed by processing module 108 simultaneously to (1) audio logic module 110, which is designed to convert the signal to digital and stream the incoming analog audio signal via a wireless network, and (2) a pass-through electrical instrument jack mechanism such as 212 from FIG. 2. The audio logic module 110 inside the jack device 100 streams the analog audio signal over the wireless network created or joined by the network logic module 112 to a host device, for example via a wireless module internal to the host device, potentially similar to wireless module 106. The audio logic module 110 supports low latency streaming of radio frequency signals over wireless networks. In an embodiment, the analog signal is converted to digital prior to being transmitted wirelessly, either by audio logic module 110 or another module. In an embodiment, jack device 100 transmits both analog and digital signals; for example, analog signals via output module 104 and digital signals via wireless transmission, although the signals may be transmitted or caused to be transmitted by other modules as well.

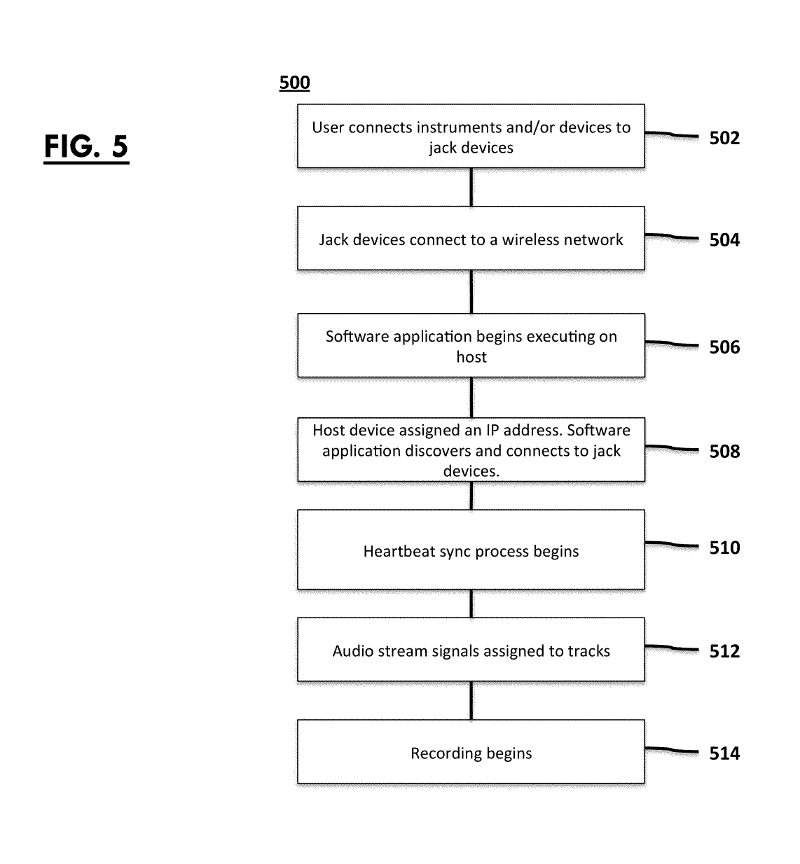

FIG. 5 is a flow chart showing an example process 500 for using a software application for connecting a network of jack devices 100 according to an embodiment. The process 500 can be implemented by the jack device 100 of FIG. 1, as implemented by the instrument jack device of FIG. 2, the MIDI jack device as discussed herein, the microphone jack device 302 of FIG. 3 or by a different device or system. In some implementations, the process 500 can include fewer, additional and/or different operations. In other examples, only one or some subset of these operations may be included, as each operation may stand alone, or may be provided in some different order other than that shown in FIG. 5. For clarity, the general jack device 100 of FIG. 1 will be referred to with regard to the description of FIG. 5, but it should be understood that the example embodiments described herein are not so limited.

According to an embodiment, a software application executes on a host device and receives wireless audio signals from a network of jack devices 100 that are wirelessly connected. The software application receives wireless signals from a wireless network of electrical jack devices, organizes, synchronizes and processes such signals internally within the host device, and outputs the signals, whether for monitoring, playback or distribution.

At 502, users connect various instruments and/or devices to the jack devices 100. As an example, a user connects a microphone jack device 202 to a microphone and presses the microphone jack device 202 power button. Another user then connects a jack device 100 to an instrument and presses the jack device 100 power button. Another user then connects a jack device 100 to an amplifier output and presses the jack device 100 power button. Another user then connects a jack device 100 to a host MIDI device and presses the jack device 100 power button 414. In an embodiment, a user can power a jack device 100 first and then attach it, or may attach the jack device 100 to the instrument, microphone, amplifier, or MIDI device and then press the power switch, as either process works the same. In addition, a single jack device 100 can be powered and form a network or any combination of any number of different types of jack devices 100 can be powered and joined to the same identical wireless network, to which the host recording device joins subsequently. Additionally, this same process of network creation can be initiated within the software application on a host device by leveraging the host device's operating system's ability to create a network instead of a jack device. In one example, network creation is initiated from jack devices 100 and the host device joins subsequently, while in another example, network creation is initiated by a software application executing on a host device and jack devices 100 join subsequently.

At 504, the jack devices 100 join a wireless network, which in an embodiment is the same network, so each jack device 100 is connected to each other via the wireless network. In an example embodiment, the jack device 100 firmware is programmed with a default network name and key, and all jack devices 100 join this network when powered up. The network SSID (the name of a local wireless area network (WLAN)) may be hidden from standard wireless network browsers in order to prevent other devices nearby from using or attempting to use the jack device 100 network for Internet access. In one implementation, the first jack device 100 to be powered broadcasts the SSID stored in its configuration file, which creates a wireless network, issuing itself an IP address and storing that address in non-volatile random-access memory (NVRAM). Subsequent, jack devices that were previously part of the same network will upon power up join the same network created by the first jack device and self-assign IP addresses. In another example embodiment, a jack device (such as the first one to be powered on) serves as a DHCP host for the wireless network and issues itself an IP address and stores that address along with the addresses of each additional electrical jack device on the network, with their corresponding DHCP client IDs, in a DHCP client table in memory on the first jack device 100, although other locations for the DHCP client table are envisioned.

In an implementation, jack devices 100 for instruments, amplifiers, MIDI devices, and microphones use radio, audio and data processing chipsets with custom firmware programmed with a default wireless network name and security key, all according to standards that would be familiar to one of ordinary skill in the art. Onboard logic (e.g., a chipset) supports self-assigning an IP address to a jack device on power-up, or receiving an IP address from a base station device if one is present, or dynamic host configuration protocol (DHCP) as both a client and server. Upon powering up a jack device 100, the jack device 100 is programmed to join a default WLAN and poll that network for a base station, or via published Bonjour, mDNS or other methods for the existence of other jack devices broadcasting the availability of the wireless streaming audio network service. In another embodiment, the jack device 100 is programmed to look for a DHCP server 400. If no DHCP server is found, the jack device 100 creates a new WLAN and serves as the DHCP server for such new network, as previously discussed.

According to an embodiment, the WLAN can be formed with one jack device 100 and software running on the host device, or multiple jack devices 100 of various kinds (whether instrument, amplifier, MIDI device or microphones or combinations thereof) and software running on the host device. The wireless network name and security key are stored in the jack device 100 firmware so that the default network can be joined again in the future for another session, or can be set to any other network name/security key combination via a firmware change written out to the jack device 100 from, for example, the software application running on the host device or other method.

At 506, the software application begins executing on the host device, for example via a user command. If the user is new to the software application and/or the jack devices 100 have not been previously identified and connected to the software application, an alert is provided by the software application prompting the user to enter login credentials necessary to join the default wireless network. After joining the default wireless network for the first time, another alert is provided instructing the user that the default wireless network settings can be changed at any time, for example within the software application.

At 508, the software application discovers and connects to any jack devices on the current wireless network. As the software application discovers jack devices, in an implementation the connection LED lights turn on for the discovered jack devices, as discussed earlier. The discovery phase can be manually restarted via the software application, for example by a user selecting a button in the settings pane of the software application. Users may reset the jack devices to disassociate from the network, for example in order to join other networks at later times, as discussed herein with respect to the reset button of FIGS. 1-3. In an implementation, the software application has the ability to forget or expunge jack devices from the network.

At 510, the heartbeat synchronization process begins, and as jack devices synchronize to the heartbeat they become available as audio sources, as described more fully herein with regard to the heartbeat synchronization.

At 512, once the jack device discovery phase is concluded and the electrical jack devices to be included in the session have been connected and identified by the software application, the user is prompted to assign the wireless audio stream signals from the discovered jack devices to one or more “tracks” within the software application. For example, there may be provided a “mixing board” screen of the software application within which the assignment of wireless audio stream signals from the discovered jack devices may be performed.

At 514, recording begins, for example by a user pressing a recording button within the software application. Signals and data emitted from the jack devices are captured in real-time in their respective assigned tracks (as discussed with respect to step 512) and are recorded within the memory storage mechanism of the host device.

In an implementation, the software application running on the host recording device can sync with a mobile application (e.g., a remote control application) that runs on an external device (such as a mobile phone or tablet) to allow a user to control various aspects of the software application (e.g., start, pause, stop and record) remotely at any time during the session. For example, a user of the remote control application can press record on the remote control application on the user's iPhone, which sends a signal to the software application running on the host device, which then triggers the live recording of the performance to begin. During a performance, the same user can press a button to pause the recording (for example, to allow the performers to take a break and discuss the next phase of the recording), stop the recording, start from the beginning, or delete the last recording altogether (e.g., undo recording or functions). The remote control application allows the user to simultaneously be a performer and a producer for the recording session without having to operate the software application directly from the host device. The remote control application gives users and performers flexibility to perform several roles at once during the recording session, eliminating the need for a dedicated person to push start and stop buttons at the right times to capture the live performance and offering freedom of mobility during the performance.

In an implementation, the software application can sync with a mobile application (e.g., a remote monitoring application) that runs on an external device (such as a mobile phone or tablet) to allow a user to monitor aspects of the real-time recording or existing recordings remotely at any time during the session. For example, a user of the remote monitoring application can use headphones plugged into or paired with the user's iPhone, which receives a monitoring audio signal from the host recording device so the user can hear what is being recorded or what has been recorded. The remote monitoring application gives users and performers flexibility to hear the recordings during the recording session, eliminating the need for additional hardware to monitor the session.

According to an embodiment, the user may apply various effects to incoming wireless audio streams, for example through effects buses within the software application before, after or during recordings. Once recording is over, users can further adjust levels, apply effects and processing, and edit with similar commands and gestures used on any other digital audio workstation known in the art. Incoming MIDI data can be used to trigger effects or other events within the software application. The software application may allow users to add processing and editing features not already within the software application via an in-application purchase mechanism which connects to a third party online store for purchase, download and installation in the software application.

In an embodiment, the software application is written as virtual studio technology (VST) and audio unit (AU) format plugins to allow professional digital audio workstation (DAW) software to use the jack devices as an audio source. Software application settings such as network name, security keys, and network privacy may be controlled from the UI of the software application, or from within the VST or AU plug-ins running within a similar third party DAW software application according to standards that would be familiar to one of ordinary skill in the art.

In an embodiment, the software application routes live signals of a performance, and recorded signals, to a host device's wireless transmitter and an output mechanism (such as a ⅛ output female jack), in order to transmit such signals to the performers and users for listening via headphones whether in real-time or at later times. The software application converts the signals captured by the software application on the host device into a radio frequency to deliver such signal as a wireless transmission to multiple headphone sets. The software application also routes the digitized signals to the ⅛ output female jack in order to transmit the digital signals to a headphone mixing device or directly to a set of headphones.

In an embodiment, the software application allows users to connect with other third party DAW software applications for interoperability, designation of control mechanisms between such software, and other cross-platform functionality including live mixing, editing, processing, mastering and outputting in a variety of formats whether in real time or for later.

The software application offers application programming interfaces (APIs) that would be familiar to one of ordinary skill in the art which can be used to ensure that content recorded by the software application can be shared with social media sharing services via the Internet. For example, a user may have a “profile” within a social media sharing service (e.g., Facebook, Twitter, YouTube, etc.) to which such user can post recorded content (such as clips, in-progress mixes, finished recordings, remixes and related metadata) to populate such user's social media sharing service profile. From that profile, the music can be shared with others including additional social media services. In example implementations, the software application allows users of the software to connect to third-party servers for storage of such recordings and additional processing and editing at later times. Users may export files of recordings via the Internet, via email, FTP connections, or to externally connected storage devices.

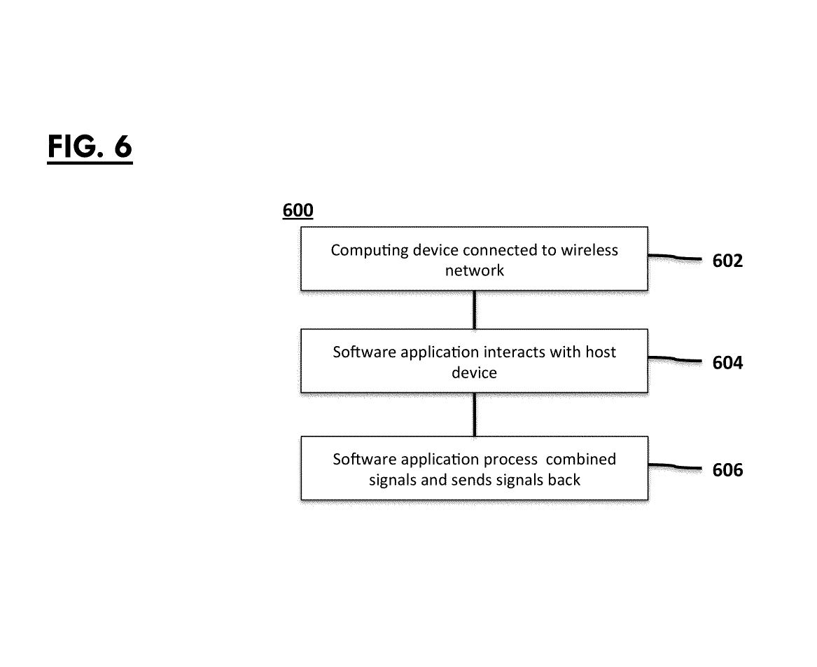

FIG. 6 is a flowchart showing an example process 600 for using a software application in combination with a computer and jack devices 100 to capture simultaneous live signals, according to an embodiment. The process 600 can be implemented by the jack devices 100 of FIG. 1, as implemented by the instrument jack device of FIG. 2, the MIDI jack device as discussed herein, the microphone jack device 302 of FIG. 3 or by a different device or system. In some implementations, the process 600 can include fewer, additional and/or different operations. In other examples, only one or some subset of these operations may be included, as each operation may stand alone, or may be provided in some different order other than that shown in FIG. 6. For clarity, the general jack device 100 of FIG. 1 will be referred to with regard to the description of FIG. 6, but it should be understood that the example embodiments described herein are not so limited.

At 602, a user connects a computing device, such as a personal computer, tablet, cellphone or other device, to the wireless network using similar approaches as those described with reference to FIGS. 4-5. In this embodiment, the computing device merely operates as another wireless input mechanism, in this implementation to facilitate video transmission across the wireless network working in tandem with the jack devices.

At 604, the software application interacts with the host device's video capability to enable users of the device to synchronize and combine audio recordings captured by the software application with live real-time video of the performers and the surroundings captured by the host device. The video signal may be organized as a separate channel within the software application.

At 606, the software application processes the combined signals and simultaneously sends back processed signals to performers for real-time monitoring and hearing the performance as it is performed wirelessly to a connected audiovisual device and streamed via the Internet. In an embodiment, the software application has the ability to route digital signals, whether those captured in real time from live performances or those previously recorded for playback at later times, via the recording device's onboard output jack plug socket or wirelessly to multiple wireless headphone sets connected to or paired with the host device and software application. An available second network connection associated with the host device (in addition to the wireless network receiving audio) may be used to broadcast the mixed audio/video signals, for example over the Internet.

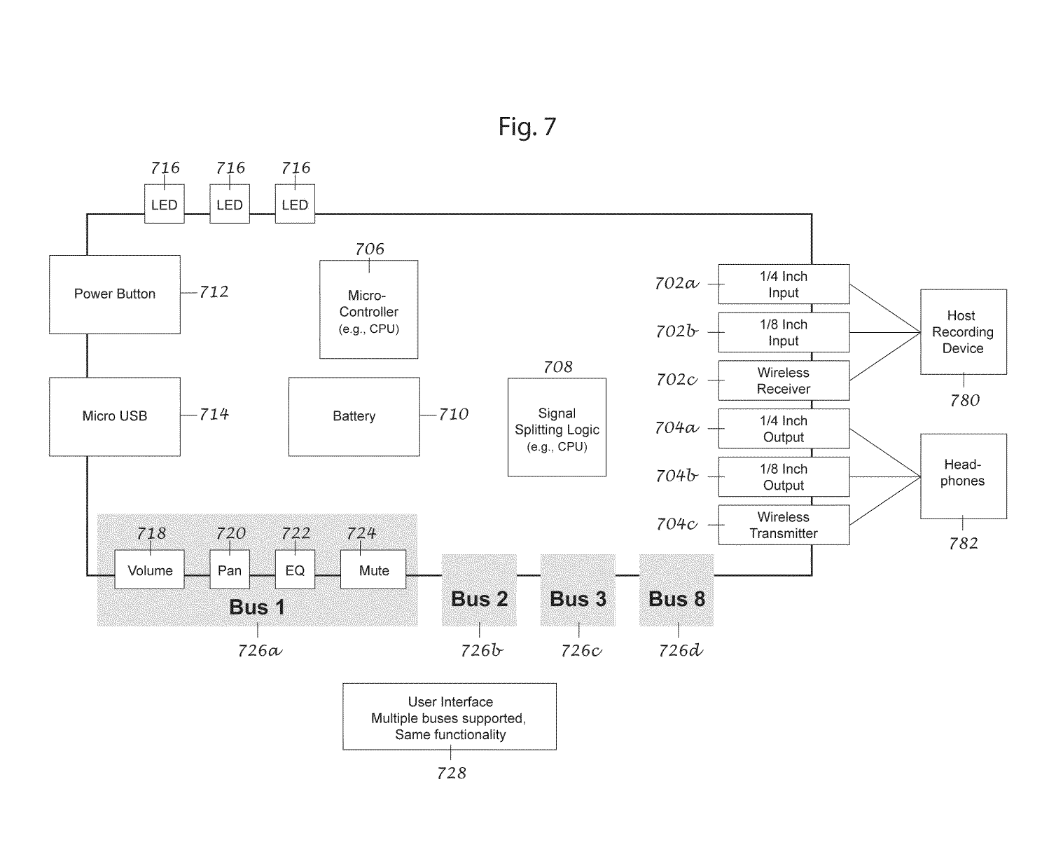

FIG. 7 is a depiction of an example wireless headphone monitoring and mixer device 700. According to an embodiment, headphone mixing device 700 is comprised of various modules programmed to perform various tasks as well as various input and output mechanisms. These modules may be implemented in hardware or software and may comprise internal connections (not shown in FIG. 7) allowing the various modules to be communicatively coupled in any desired configuration, as well as allowing one or more modules to be communicatively coupled to external devices. Additional modules not explicitly shown in FIG. 7 may also be included in headphone mixing device 700 in other implementations, and modules and/or their functionality may be combined or divided into further modules in certain embodiments.

In an embodiment, headphone mixing device 700 operates with a host device 780 and receives wireless digital signals of sounds from host device 780. In an embodiment, headphone mixing device 700 is adapted to be connected to host device 780 (via such host device's onboard electrical jack receiving socket or by means of wireless signal) during use of headphone mixing device 700.

In an implementation, headphone mixing device 700 comprises input mechanisms 702a-702c for receiving digital signals. These may include a receiver for wireless signals 702c; a standard one-eighth (⅛) inch jack plug socket 702a to connect to host device 708 and receive digital signals from host device 780 (the ⅛ inch socket is in one implementation intended to connect directly with host device 780 with a connecting cable); a standard one-fourth (¼) inch jack plug socket 702b to connect to host device 780 and receive digital signals from host device 780 (the ¼ inch socket is in one implementation intended to connect directly with host device 780 with a connecting cable). These input mechanisms 702a-702c may comprise any input mechanism known in the art, such as standard analog plugs, a USB port, an IEEE 1394 interface (also known as “FireWire”), and/or other connection ports and standards.

Headphone mixing device 700 may further comprise output mechanisms 704a-704c for outputting digital signals. These may include a transmitter for wireless signals 704c which may operate to transmit multiple signals simultaneously via a wireless emission mechanism to a variety of devices including but not limited to the software monitoring application (detailed above), jacks, a set of wireless headphones 782 including headphones paired via Bluetooth technology. The headphone mixing device 700 may offer multiple wireless output mechanisms 704c to allow multiple performers to simultaneously hear digital signals from a host device 780 in order to monitor aspects of a live performance in real time (as such sound is being created) or during playback at a later time for sounds already captured by host device 780. The output mechanisms 704a-704c may further include a standard one-eighth (⅛) inch jack plug socket 704b to connect to headphones 782 and a standard one-fourth (¼) inch jack plug socket 702b to connect to headphones 782. These output mechanisms 704a-704c may comprise any output mechanism known in the art, such as standard analog plugs, a USB port, an IEEE 1394 interface (also known as “FireWire”), and/or other connection ports and standards.

Headphone mixing device 700 may comprise a processing module 706 for implementing commands (such as power, reset, volume, pan (for left to right), equalization and mute) directed by users of headphone mixing device 700 from the UI 728; and a signal splitting logic module (e.g., an internal chipset) 708 for receiving a digital signal and splitting such signal into multiple wireless signals.

In an embodiment, the input mechanisms 702a-702c of headphone mixing device 700 receive digital signals and wireless signals of radio frequency transmissions from the software application running on host device 780, and routes such received signals to processing module 706. Headphone mixing device 700 may receive wireless signals of radio frequency transmissions from host device 780 via headphone mixing device's 700 wireless receiver 702c.

Headphone mixing device 700 may also be connected to host device 780 via standard cabling to receive a digital input signal. Multiple inputs allow users flexibility to determine how headphone mixing device 700 shall receive digital signals from host device 780. In an embodiment, headphone mixing device 700 has a bus of female jack plug sockets 702a-702b designed to connect to host device 780 via ¼ inch and ⅛ inch cabling. Upon inserting a cable into the host device 780 output socket, and the other end into the headphone mixing device's 700 input mechanism 702a-702b, a digital signal is sent from host device 780 to processing module 706.

Processing module 706 within headphone mixing device 700 sends signals received from host device 780 to signal splitting logic module 708 inside headphone mixing device 700 that splits the signal from host device 780 into multiple wireless output signals. The signal is split in order to route such split signal to separate buses 726a-726d in headphone mixing device 700 so that each performer can receive a mix of the signals received from the host device 780. While eight buses 726a-726d are illustrated in FIG. 7, it is contemplated that any number of buses may be implemented.

The headphone mixing device 700 may transmit to, or pair with, multiple sets of wireless-enabled headphones 782 so each performer can monitor and hear the sound being performed in real-time, or hear the playback of previously recorded sounds. The headphone mixing device 700 allows multiple customizable mixes depending on which sounds any given performer chooses to hear for each set of paired headphones 782. The users may customize the mix (changing volume 718, panning the mix to the left or right 720, applying equalization 722, and muting a channel 724 as desired) via controls and commands applicable to each separate bus 726a-726d and corresponding to each specific intended output channel. The headphone mixing device 700 allows a performer to create a specific mix for that performer's desired overall volume (e.g., vocals louder than guitars) or to control the volume of the entire mix of all combined signals (e.g., turn up the entire band). This allows performers to hear themselves at a higher volume in their own mix relative to the other performers. The headphone mixing device 700 supports several separate buses 726a-726d, each customizable to the performer's choices.

The headphone mixing device 700 is powered by a rechargeable (e.g., a lithium-ion) battery 710. The battery is connected to a bus module (e.g., micro-USB interface) 714 for recharging purposes. To extend battery life, headphone mixing device firmware programming supports cutting power to the onboard logic (e.g., internal chipsets) if no network is present or the headphone mixing device 700 is not connected to software on a host device 780.

Headphone mixing device 700 may provide an external UI 728 and various controls and features. The controls and features may include a power button 712, a set of mixing knobs 718-724 to determine parameters of the outputted mix (typical parameters include volume, panning left to right, equalization and mute), a bus module 714 (for connecting to a computer or a micro-USB power source to recharge the headphone mixing device's battery), and LEDs 716 which may operate to tell the user certain information. The information may include: (i) the headphone mixing device 700 has power; (ii) network status (i.e., the headphone mixing device 700 is or is not connected to a wireless network of other electrical jack devices); and (iii) software connection (i.e., headphone mixing device 700 has connected to recording software running on the host device 780).

### Wireless Audio Driver Interface

As discussed above, previous approaches to recording multiple performers during a live performance requires a significant investment of resources, both in money and time. It isn't as simple as it should be for a few performers to just pick up their instruments and jam, while recording the live performance for later review and distribution. Implementations of the currently described techniques operate to minimize these difficulties. With the wireless jack devices, it is easy to plug multiple wireless jack devices into instruments and/or devices, ranging from microphones to guitars to MIDI devices to computing devices. Once plugged in, the devices are able to create or join a wireless network connecting the wireless jack devices, the network including a host device and software application that provide varied functionality from recording the audio signals transmitted over the wireless network by the wireless jack devices into one or more tracks, to providing a user interface for various parameters of the system, to offering ways to apply effects processing to the audio signals for each stream of audio from individual wireless jack devices and sending that processed audio signal data back to a performer so she can listen to her performance in real-time as it is being recorded.

While aspects of the functionality previously described are embodied in portions of hardware and/or software, such as the wireless jack devices, the host device and the software application among others, embodiments of the present approach comprise a wireless audio driver interface that in certain embodiments serves as an underlying engine for the overall implementation. Example implementations of the wireless audio driver interface may be implemented in hardware and/or software and may operate independently on one or several devices. The functionality described herein may be offered by a single implementation or divided among two or more modules that may be executing on one or more devices, such as a computer, a mobile device, a specialized audio device or any other device capable of executing instructions. While reference is made to a “wireless audio driver interface,” it should be understood that no limitation on the particular implementation of the described functionality is intended by the use of the terms “driver” or “interface,” as functionality that may be implemented in software may be implemented in hardware and vice versa.

The wireless audio driver interface in an example embodiment operates to receive wireless audio data from the wireless jack devices and transmit it to a control application, such as the software application previously described as executing on a host device. The wireless audio driver interface may operate to connect audio signal data delivered through an active WLAN connection to an audio subsystem of the host device or software application executing on the host device. The functionality offered by the wireless audio driver interface is independent of any particular operating system or protocol; for example, the wireless audio driver interface allows data from the wireless jack devices to be used by an implementation of the software application as previously described, or commercial software packages such as Pro Tools, which can interface with custom hardware and execute on a variety of operating systems.

Certain operating systems and software packages my provide APIs or other interfaces that allow access to certain parameters that the wireless audio driver interface may use to manage the overall system of wireless jack devices. For example, an operating system like MacOS may offer APIs that the wireless audio driver interface may utilize to ascertain data describing the status and characteristics of an underlying wireless network, while other operating systems like iOS may not offer such a full experience. In either case, the wireless audio driver interface is capable of performing all functionality necessary to manage the wireless jack devices, as described herein.

In an implementation, upon powering up and connecting one or more wireless jack devices, the wireless audio driver interface offers varied capabilities. The wireless audio driver interface begins executing on a host device and discovers the wireless jack devices. For example, the wireless audio driver interface may use a networking protocol such as Bonjour from Apple (known as mDNS in non-Apple implementations) to identify the wireless jack devices. The wireless audio driver interface establishes a list of network services that it consumes (such as wireless streaming audio) and polls for jack devices advertising those services. By maintaining control over the network service identifier and the network port used to advertise the service, only appropriately credentialed network jack devices may be discovered. For each wireless jack device discovered, the wireless audio driver interface exchanges bi-directional control data to verify parameters of the wireless jack device. Examples of control data sent from the jack devices to the wireless audio driver include jack device type, name, sample rate, time slot assignment and number of channels present in the streamed audio signal.

Once the wireless jack devices are discovered and the control data transmitted, the wireless audio driver interface transmits a “heartbeat” synchronization signal to the wireless jack devices, as will be described more fully herein. Once the wireless jack devices have synchronized with the heartbeat signal being broadcast by a controller (such as the software application executing on the host device), the wireless audio driver interface operates to receive audio signal data from the wireless jack devices and facilitates transmission of that data to another component, for example the software application. This transmission may be facilitated by underlying functionality provided by any operating system, such as CoreAudio in MacOS. While reference is made to CoreAudio, it is understood that this functionality is possible in any number of different software and/or hardware environments.

In an example, the wireless audio driver interface receives the audio signal data over a documented network interface and then makes it available over a host OS audio interface; for example, by transmitting the audio signal data to CoreAudio. The wireless audio driver interface notifies CoreAudio of various parameters of the audio signal data, such as the number of channels. In this instance, if the wireless audio driver interface notifies CoreAudio that there are 8 channels of incoming audio, then any application that communicates with CoreAudio will see that there are 8 channels of audio.

The wireless audio driver interface may then poll for the Phase Lock Loop (PLL) status of the connected wireless jack devices, as will be described more fully herein. Until the wireless audio driver interface has confirmed that the wireless jack devices are connected and in sync, no audio signal data may be transmitted and the audio subsystem of the software host device's operating system (such as CoreAudio) has no knowledge of the jacks.

Prior to the advent of wireless audio transmission, performers used custom hardware audio boxes that plugged into a computer in order to transmit audio signal data to a computing device. Because these boxes were implemented in hardware, the computing device could easily establish how many channels of audio signal data were being contemplated. For example, if an 8-channel hardware box was plugged into a computing device, then the software executing on the computing device prepared 8 channels of audio signal data, and likewise with 4-channel and 16-channel hardware boxes.

In example implementation of the current approach, the number of incoming audio channels from the wireless jack devices is unknown until the devices are connected, and the number may change in real-time as jack devices appear on the network or disappear from the network. Perhaps a new performer connects a wireless jack device, or the wireless network deteriorates so that it cannot handle as many streams of audio signal data at a selected quality level. Implementations of the current approach create a virtual hardware box for the instruments and device to “plug” into. Because there is no physical connection between the wireless jack devices, the wireless audio driver interface (in whatever form the functionality may take) constantly identifies which wireless jack devices are connected, provides this information as needed to other applications and/or devices, and enables the transmission of audio signal data from the wireless jack devices.

The wireless audio driver interface may operate as if it were a physical hardware device connected to a computing device, but the audio signal data is not being transmitted via standard hardware approaches. Additionally, the characteristics of the wireless network to which the wireless jack devices, the software application(s) and the host device(s) are connected are constantly changing. Based on what number and type of devices are connected, and other aspects such as desired recording quality, the physics of the wireless connection may impose limitations on what is possible. The wireless audio driver interface monitors these parameters and ensures the audio signal quality is acceptable.

In an example, suppose there are eight performers at a coffee shop who wish to utilize the wireless network in the coffee shop to connect their wireless jack devices and record a live session. If, as expected, the wireless network in a busy coffee shop is congested with numerous devices connected to it, then the probability of getting a pristine recording over the network is low. As will be described herein, various network health metrics may be monitored and analyzed to determine an optimal list of parameters for recording. The wireless audio driver interface, in one example through a user interface, provides an alert to users that the present network conditions are not acceptable to record audio meeting the requested standards. In the coffee shop example, it may not be possible to record 44.1 kHz audio from 8 channels. Perhaps only 4 channels can be recorded at 44.1 kHz, or all 8 channels may be recorded at a lower sample rate. The wireless audio driver interface operates to determine these operating parameters and provide this information to users, along with alternate proposed scenarios.

In an example embodiment, if the performers desired to go ahead, the wireless audio driver interface will dynamically alter selected parameters in order to maximize the quality of the recording for the desired settings. For example, the wireless audio driver interface may change the number of incoming channels of audio signal data, increase the size of the network buffer, lower the sampling rate or bit-depth for one or more channels of audio signal data, or take other actions related to the audio signal data and/or network parameters.

The wireless audio driver interface may also receive and store metadata, for example about the wireless jack devices, wireless networks, etc. Example metadata may include a name for a wireless jack device, registration information, a user ID, a network name, security parameters associated with a wireless network, time code data (such as Society of Motion Picture and Television Engineers (SMPTE) time code data), and so forth.

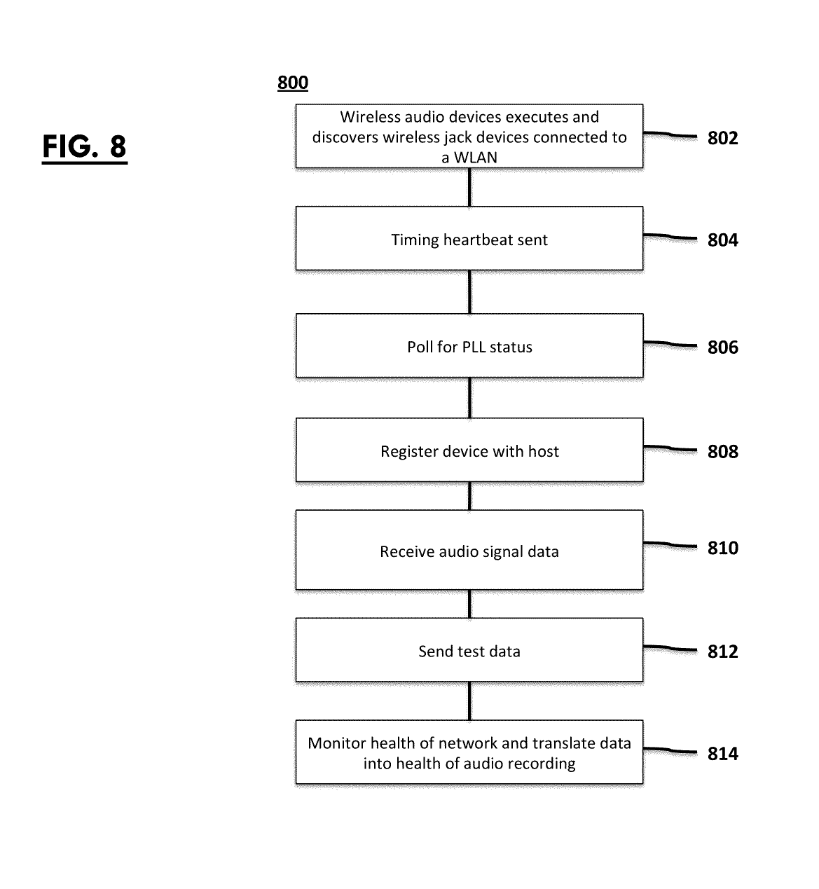

FIG. 8 is a flowchart showing an example process 800 for using a wireless audio driver interface in combination with wireless jack devices to capture simultaneous live signals, according to an embodiment. In some implementations, the process 800 can include fewer, additional and/or different operations. In other examples, only one or some subset of these operations may be included, as each operation may stand alone, or may be provided in some different order other than that shown in FIG. 8. While the functionality of the wireless audio driver interface may be described herein as being performed by a single entity, it is understood that other envisioned devices and modules, operating independently or concurrently, may perform the functionality described herein.

In 802, the wireless audio driver interface begins executing and operates to discover all active wireless jack devices connected to a wireless network. This step could be accomplished by a network protocol (e.g., WiFi, ad-hoc, etc.) direct handshake, or may use core components of an operating system such as Bonjour. Using Bonjour (known as mDNS in non-Apple implementations) for the discovery phase, the wireless audio driver interface establishes and stores a list of network services that it consumes (such as wireless streaming audio) and polls for jacks advertising those services. In an embodiment, this process operates continuously to discover the status of devices in real-time. The wireless jack devices may be executing code to make the wireless streaming audio service available, such as mDNS responder. For each wireless jack device discovered by the wireless audio driver interface, bi-directional control data is exchanged to perform certain tasks, such as verifying functionality. Examples of such control data sent from the jack devices to the wireless audio driver may include jack device type, name, sample rate, and number of channels present in the streamed audio signal.

At 804, the wireless audio driver interface begins sending a timing packet (such as the heartbeat described more fully herein) to all wireless jack devices present on the currently-active wireless network.

At 806, the wireless audio driver interface polls for the PLL status of all wireless jack devices present on the currently-active wireless network. In an embodiment, no wireless jack device will be made available to an audio subsystem of a connected device until the PLL status of all wireless jack devices is true.

At 808, the wireless audio driver interface registers a wireless jack device with the host device comprising a number of channels of audio equal to the number of wireless jack devices present on the currently-active wireless network. In an example, the wireless audio driver interface may communicate the number of incoming audio channels to the CoreAudio subsystem of the computer running MacOS and operating as the host device. In another example, the number of incoming audio channels may be communicated to a software application operating on a mobile device (such as an iPad or iPhone) that is acting as the host device. In an example, the number of inbound channels may be represented by separate devices or may be aggregated into a subset of inputs.

At 810, the wireless audio driver interface operates to receive the audio signal data being wirelessly transmitted by the wireless jack devices. This may be accomplished by utilizing a currently active wireless network connection and instructing all wireless jack devices present on the currently-active wireless network to begin streaming audio signal data to a host device, in an example to a software application or core subsystem executing on the host device. In an implementation, the control language used by the wireless audio driver interface, audio subsystem such as CoreAudio and software applications is implemented using an API such as IOAudioControl objects or a similar interface. The commands sent to the wireless jack devices may be translated prior to or during transmission.

The particular audio transport mechanism used by the described approach may be selected from a mechanism known in the art, such as BSD sockets over TCP, or may be implemented using custom code. In an embodiment, parameters such as timestamps, acknowledgment data (ACKS) and other data may be used, for example to allow use of UDP as a lower latency alternative.

At 812, the wireless audio driver interface (or another software application) may send test data to all wireless jack devices present on the currently-active wireless network. This data can be used to calculate network health (before wireless audio streaming begins), bandwidth throughput between each jack device and the host recording device software application, transmission signal strength, network congestion and possible interference from other nearby wireless devices.

At 814, the wireless audio driver interface in real-time continuously monitors the health of the wireless network on which the devices are connected and communicates data describing the network health and the ramifications to entities such as the wireless jack devices and to users through a user interface. In one example, the wireless audio driver interface establishes and stores a set of thresholds for network health by correlating data acquired from operating system modules and/or APIs. These thresholds may correspond to particular “modes” of the wireless jack devices, which modes may operate to set or alter audio signal data streaming parameters, resulting in optimization of the audio signal data for best performance and/or quality given a particular network state. The wireless audio driver interface may send messages to the wireless jack devices that changes these modes in real-time based on the changing health of the wireless network. The wireless audio driver interface, in one example through a user interface, display alerts and/or messages to the users of all wireless jack devices present on the currently-active wireless network about these mode changes.

To illustrate the described process 800 with an example: 3 performers gather in a room and decide to play live, and they wish to record the resultant audio using the techniques described herein. One performer has a microphone and plugs a microphone jack device 302 (as described with reference to FIG. 3) into the microphone. Another performer plugs a wireless jack device (as described with reference to FIGS. 1-2) into a guitar. The third performer plugs a wireless jack device into a MIDI device. The wireless jack devices are powered on and attempt to connect to an existing wireless network; for example, the default WLAN stored in memory at the wireless jack devices. In this example, the default WLAN is available in the room, and the wireless jack devices connect to the WLAN.

The wireless audio driver interface is then executed, for example by opening a software application on a host device. This may be a custom application executing on a mobile device, or may be a professional software package such as Pro Tools executing on a computer. The wireless audio driver interface searches for all wireless jack devices present on a particular wireless network. For example, the wireless audio driver interface may have stored a default network, similar to the wireless jack devices, or it may scan for all available wireless networks and present a list of the networks to a user, who may select the network to which the wireless jack devices are connected. In other embodiments, the correct network is automatically discovered and identified using techniques known in the art.

Once the wireless audio driver interface has identified all wireless jack devices present on the currently-active wireless network, the wireless audio driver interface begins sending a timing packet stream, or heartbeat message stream (as will be more fully described herein) to the wireless jack devices, and polls the wireless jack devices for their PLL status. Once the wireless audio driver interface confirms the PLL status of the wireless jack devices, it registers three channels of inbound audio signal data with a software application executing on a host device, which in this case is Pro Tools executing on a computer.

The wireless audio driver interface then signals the wireless jack devices that it is ready to receive audio signal data, and in one implementation the wireless jack devices alert the performers that all is ready, for example by lighting a LED indicator light or using audio signaling. The performers begin playing, and audio signal data begins streaming wirelessly from the wireless jack devices to the software application on the host device.

The wireless audio driver interface continuously monitors the audio signal data and the wireless network to confirm all three devices may consistently deliver audio without any interruption or degradation in quality.

Using the test data results and approaches to monitor the wireless network parameters (for example, by getting data from operating system APIs related to network parameters, such as signal strength, packet loss, etc.) the wireless audio driver interface translates this information info a metric describing the status of the audio signal data as it relates to what the performers requested and what is possible under the current network conditions, which are constantly changing. This metric in one implementation takes the form of “mode” data that is determined by the wireless audio driver interface and transmitted to the wireless jack devices, ultimately being communicated to the performers.

For example, prior to beginning the performance session, the performers may choose a “high quality” mode, which may be predetermined as being up to 8 channels of audio at 44.1 kHz sampling rate. Modes may be customized on the fly as well based on selections made from lists of conditions. Based on this mode selection and the wireless network status, the wireless audio driver interface analyzes whether this mode is possible under the existing network conditions. In this case, the network is analyzed and the wireless audio driver interface determines that the mode is possible; therefore, the three streams of audio signal data may be transmitted and recorded at 44.1 kHz. If it were not possible, in an alternate embodiment, this would be indicated to the users and various options presented. For example, an option to record up to two channels of 44.1 kHz audio may be selected, or up to four channels of 22 kHz audio. The possible combinations are only limited by the number of parameters supported.

During the performance, a laptop joins the wireless network and begins streaming a movie from a website. The throughput of the wireless network drops as a result of the congestion, and the wireless audio driver interface identifies that the current mode cannot be maintained. As a result, the wireless audio driver interface may send mode change messages to the wireless jack devices, indicating that parameters of the current recording session are going to have to be altered (e.g., number of channels, sample rate, etc.). These mode change messages may be communicated to the performers via a user interface mechanism, and a new mode may be selected from a list of possible modes, as determined by the wireless audio driver interface. In another example implementation, the wireless audio driver interface, determining that the current mode is untenable for the requested recording parameters, operates to change the streaming parameters in real-time so as to maximize the audio streaming quality given the current wireless network state. This may include changing packet size or other characteristics of the transmission, or altering recording parameters on the fly. Notifications of such changes may be communicated to the performers, depending on predetermined settings. The wireless audio driver interface continuously monitors the wireless network and changes parameters of the system to compensate.

For example, in response to the laptop streaming a movie on the wireless network, the wireless audio driver interface may have changed the packet size to attempt to compensate for the network congestion. Once the laptop stops streaming the movie and the network congestion eases, the wireless audio driver interface may automatically change the packet size back to a previous setting.

According to an example embodiment, a companion application may be provided to relay information from the wireless audio driver interface to users, as well as to receive commands and data or provide functionality. For example, an iOS app executing on an iPad or iPhone may comprise functionality provided when a host application calls the wireless audio driver interface. The companion application, in various embodiments, displays user messages about operation of the wireless audio driver (such as network health, jack device configuration settings, number of jack devices on the network) and also has input screens for the creation and maintenance of control and configuration data.

### Network Health Analysis

As discussed above with regard to the wireless audio driver, such as the interface elements, an aspect of the present approach comprises monitoring the status of the wireless network health, and also has input screens being used for the creation audio signal transmission. According to an example embodiment, a set of data related to wireless network measurement (or “health”) are provided along with a set of data related to the transmission of audio signals, in one example specifically related to the transmission of wireless audio signals. Given a particular network environment and desired audio parameters, the two data sets are analyzed and action taken as a result.

In an example implementation, this data may be comprised in a matrix, which matrix may be stored on any device capable of storing data and made accessible to all components, for example the wireless audio driver interface and/or a software application executing on a host device. Implementations other than a matrix are envisioned, as the data may take any form and be stored in any manner known in the art; however, a matrix implementation will be discussed herein. This should not be construed as a limitation upon the nature, presentation, storage and/or access of such data.

One section of the matrix may comprise a set of parameters and/or measurements related to a wireless network, which data may be based on actual measurements using methods known in the art. For example, the parameters may comprise data that are inherent to all wireless networks, such as: frequency, throughput, network transmission protocols, wireless network standards (e.g., 802.11a/b/g/n), packet loss, interference, and so on. These parameters allow an analysis of what is going on with regard to a wireless network; for example, what is its strength and/or health?

Another section of the matrix may comprise a set of parameters and/or measurements related to audio signal transmission, which data may be based on actual measurements using method known in the art or be calculated based on particular device characteristics. For example, the parameters may comprise data such as: the amount of throughput required per channel of audio, the amount of packet loss that is allowable before the audio signal quality degrades, the amount of throughput required for particular sample rates, and so on. Further parameters may be specific to the present approach as described herein, for example: what type of wireless jack devices are being used, what are the capabilities of the host device and/or software application executing on the host device, and so on. A received signal strength indicator (RSSI) is a commonly available indicator of wireless signal strength, which is available from the network stack of the operating system running on the host device. Data transmission speed can also be used to calculate network health and capabilities. Sending test audio can generate data on packet retransmits which also represents or can be used to determine network health.

Given this matrix of data, an embodiment may receive data, for example comprising the current state of a wireless network as well as data comprising the desired quality of audio. For example, a user may be given an option to select “studio quality” or “CD quality,” among other potential options. A “studio quality” preset may comprise particular settings for the audio, such as a very high sample rate or a certain tolerance for latency, while another preset such as “CD quality” may comprise less strenuous settings for the audio, such as a lower sampling rate or lower quality audio. These settings comprising desired characteristics of audio, as discussed previously, may comprise any value capable of being selected or input by a user, or may be grouped into a preset as just discussed.

Based on the current state of the wireless network and the desired quality (or other characteristics) of the audio being transmitted, the matrix of data may be evaluated to determine whether the desired outcome can be achieved. In one embodiment, a “network health metric” is computed based on the available data.

Using this matrix of data and/or the computation of a network health metric, a user may be guided to optimal settings based on the current network status and the available settings with regard to the audio transmission and recording. For example, a user may be presented with information such as, “given the current network status and your chosen audio parameters (e.g., number of streams, quality, sample rate), your optimal settings to achieve your goal should be X,” where X represents a particular set of parameters available to be chosen by a user. This is useful because when a parameter related to audio quality changes, for example going from a bitrate of 256 Kbps to a bitrate of 512 Kbps, the burden on the wireless network to transmit that audio signal data changes. By analyzing data related to network parameters/measurements and audio quality requirements, a maximum quality capable of being achieved under the current network conditions may be determined. In one example, a user may decide to proceed with a chosen setting despite being alerted that the ultimate quality of the recording may not match what the user desires.

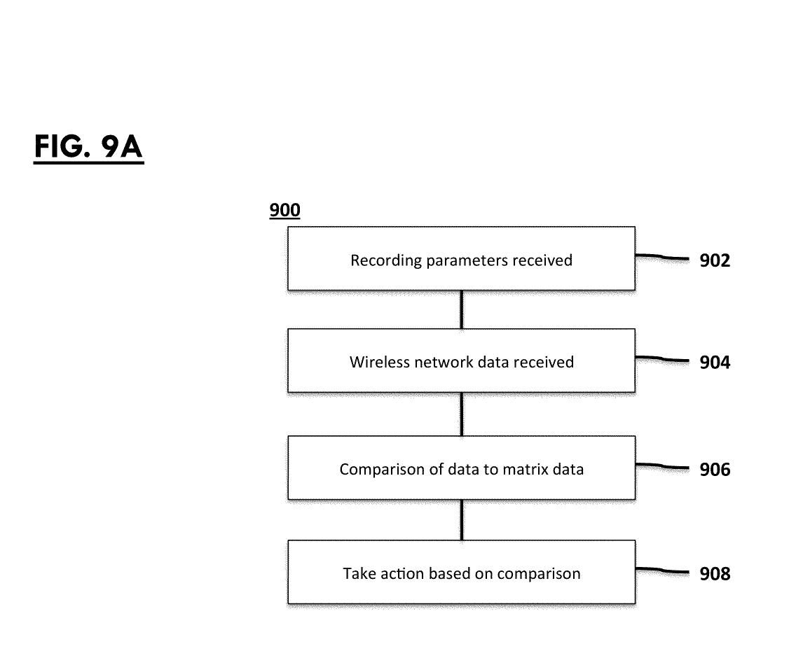

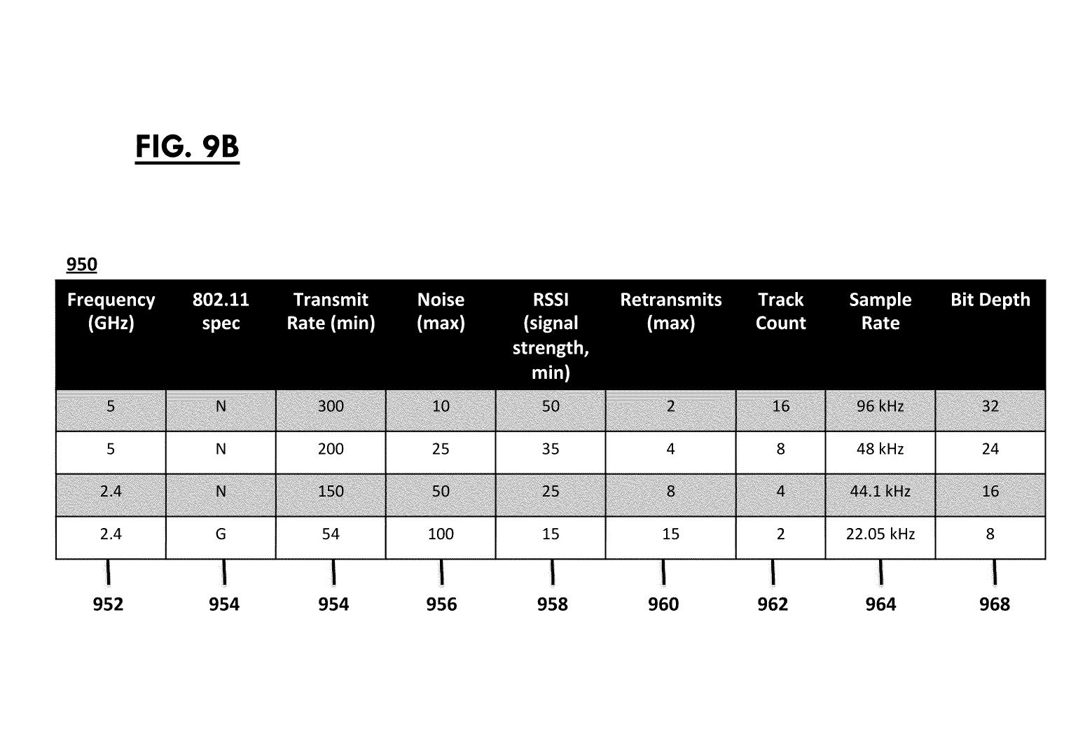

FIG. 9A is a flowchart showing an example process 900 for using data related to network conditions and/or measurements and data related to audio transmission and/or recording in order to take a particular action, according to an embodiment. In some implementations, the process 900 can include fewer, additional and/or different operations. In other examples, only one or some subset of these operations may be included, as each operation may stand alone, or may be provided in some different order other than that shown in FIG. 9A.

At 902, a set of desired parameters for a proposed recording is received, for example by the wireless audio driver interface. This may be achieved, for example, by a user selecting from a list of predetermined criteria or by inputting each parameter individually.

At 904, a set of data related to the current state of the wireless network is received. This data may comprise measurements obtained via an API to an operating system interface or via another method known in the art for acquiring the measurements.

At 906, the data received in steps 902 and 904 is stored and compared to an analysis of a matrix of data related to wireless network characteristics and data related to wireless audio transmission. In one embodiment, the comparison is represented by a metric that summarizes the relationship between the current network status, the desired recording settings, and the data in the matrix.

At 908, an action is taken based on the comparison and analysis. In one embodiment, the action may comprise providing a suggestion to a user of an appropriate set of parameters for a recording that takes into account the current network conditions and the strain on the network that will be created by a particular set of desired recording settings. In another example, a user may be provided a warning that current network conditions, when considered in light of the desired recording settings, may not result in the level of quality sought by the user.

In another embodiment, the action may be taken in real-time during transmission and/or recording of the audio signal. This adaptive recording approach continuously monitors the wireless network conditions and adapts the system to the conditions. For example, if a user selects a high recording quality, and during the recording the wireless network degrades to a level that cannot support the desired level of recording quality, various characteristics of the audio signal or network may be adapted on the fly, for example by the wireless audio driver interface or a software application executing on a host device.

FIG. 9B is a flowchart showing an example matrix 950 as described herein. While example matrix 950 contains various data points and measurements, it should be understood that the specific implementation of a matrix 950 as discussed herein may be comprised of any number or type of data.

The example embodiment of matrix 950 in FIG. 9B contains multiple rows of data for the following columns. Frequency (in gHz) of the wireless network 952, which revision of the 801.11 networking specification the network utilizes 954, the minimum transmission rate of the network 956, the maximum amount of noise 958, the calculated received signal strength indicator (RSSI) 960 as described above, the maximum number of retransmits 962. By performing calculations on this example data, the software application running on the host device can display user messaging suggesting realizable alternatives, given current network conditions, for track count sample rate and bit depth. The software application running on the host device will in an embodiment always prompt the user to select the preferable realizable system configuration given network conditions before recording.

### Providing a User Interface

As discussed above with regard to the wireless audio driver interface and the network health analysis (both sections being relevant to the techniques discussed herein), current approaches to wired audio signal transmission, for example to a Pro Tools device, involve a fixed number of inputs/channels. In the 8-channel Pro Tools hardware device case, a software component such as a driver communicates with the hardware device and always “sees” 8 channels of incoming audio. A mixing and/or recording software application communicates with the driver and also sees 8 channels of incoming audio. If one desires to utilize 9 channels of audio, then another hardware device must be plugged in.

In some existing approaches, the mixing application recognizes the set number of incoming channels and displays user interface elements (such as mixing “widgets” for each incoming audio channel) regardless of the actual number of instruments or devices connected to the hardware box. For example, even if there is only a guitar plugged into an 8-channel hardware Pro Tools device, the mixing application will display 8 user interface elements corresponding to those 8 channels.

Embodiments of the present approach recognize all wireless jack devices present on the currently-active wireless network and generate user interface elements corresponding to the actual number of connected devices. In addition to recognizing all random variable inputs that may exist with the described embodiments, example implementations also monitor the number of inputs is real-time, changing the user interface elements as devices join or drop off the network.

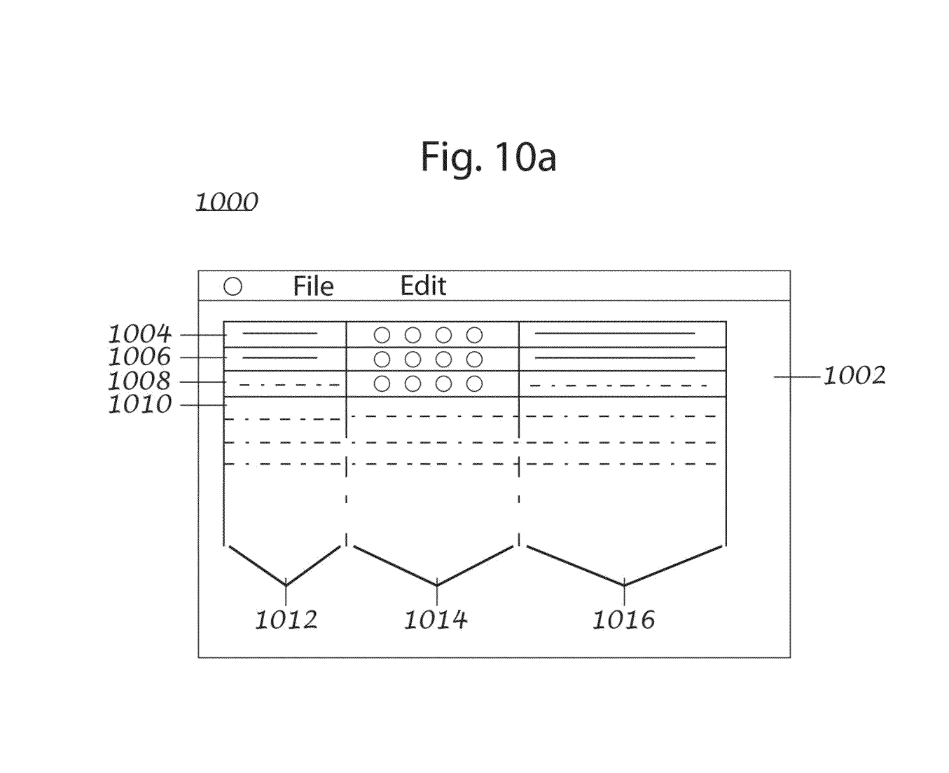

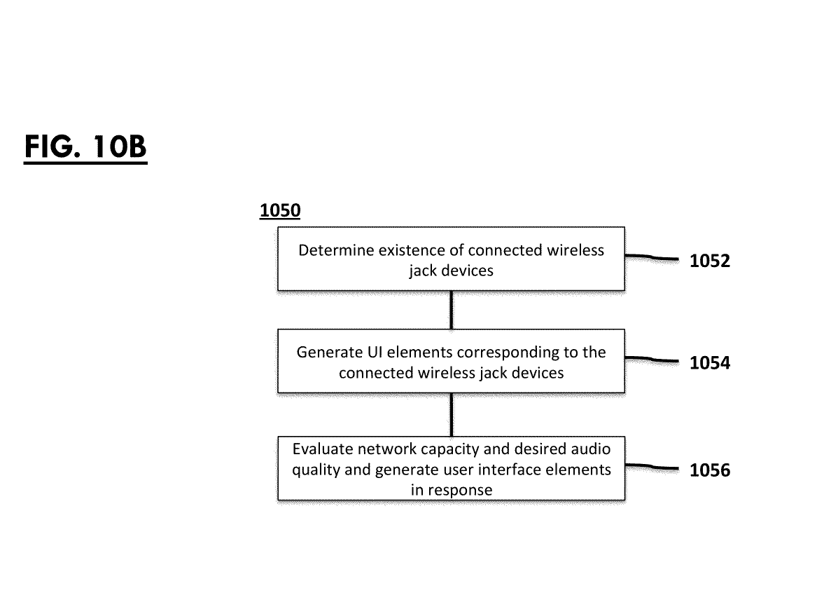

FIG. 10A is a depiction of an example display 1000 of user interface elements generated by an example embodiment. In the example of FIG. 10A, the user interface elements are being generated with regard to a mixing/recording software application 1002, which in some embodiments comprises the software application executing on the host device as discussed herein. While specific user interface elements are discussed with regard to FIG. 10A, it should be understood that any number and/or form of interface elements may be utilized, and that the examples discussed herein should not be construed as limiting the current techniques to only the described elements. Additional interface elements not explicitly shown in FIG. 10A may also be included in display 1000 in other implementations, and the elements and/or their functionality may be combined or divided into further elements in certain embodiments.

Turning to the example embodiment of FIG. 10A, the software application 1002 comprises user interface elements 1004-1010 that correspond to incoming tracks of audio being transmitted over a WLAN by wireless jack devices. In the example of FIG. 10A, it may be seen that the user interface elements 1004-1010 are arranged in rows and contain various segments. While the exact display, arrangement and content of the user interface elements 1004-1010 may vary depending on the embodiment, in this example each row contains three segments. The first segment 1012 may correspond to an identifier, such as the user ID of a performer currently using the wireless jack device corresponding to the particular row (such as “GeoffP”), or the instrument to which the wireless jack device is connected (such as “Bass Guitar 1”), or a custom identifier (such as “Geoff's Bass Guitar”) that in some implementations may be stored and recognized each time the particular wireless jack device is connected. The second segment 1014 may contain user interface controls such as representations of mixing knobs, or any other content. The third segment 1016 may contain another user interface element, such as a timeline and waveform of the incoming audio being transmitted to software application 1002 from the particular wireless jack device.

As previously discussed, because of the lack of a hardware device to which instruments are connected, the present techniques recognize the notion of multiple random variable inputs. In an embodiment, only the appropriate number of user interface elements 1004-1010 are generated based on the number of wireless jack devices present on the currently-active wireless network and of those, potentially a subset which have chosen to stream audio to the software application (because a performer with an active wireless jack device may choose not to play during a particular track and may turn his instrument off, for example). In the example of FIG. 10A, only two wireless jack devices are active and transmitting audio signals, as represented by the solid lines of the first two rows 1004, 1006.

While only two wireless jack devices are operating, it is determined (by, e.g., the wireless audio driver interface or other component) that the wireless network may support up to four wireless jack devices transmitting audio at the current quality settings (as described more fully above). Therefore, an example embodiment may display this unused “capacity” of tracks in a manner so as to highlight them as being potential tracks rather than actual tracks. This may be accomplished by displaying the potential tracks in a different visual style than the currently-active tracks. The dashed lines of the bottom two rows 1008, 1010 in FIG. 10A illustrates this concept. Examples of different visual styles may include different colors, shading, transparency or any other manner of visually distinguishing the unused but available tracks.

In an embodiment, the wireless network is constantly being monitored to determine the capacity for wireless jack devices streaming audio signals at the current quality settings. In the event that the wireless network condition improves to a point where an additional “slot” opens up, a new row may be displayed in response. This displaying may be accompanied by a visual embellishment to signify that a new track has been added; for example, the new track may gradually “slide” downwards into view from the current bottom row, or may “spring” into existence with a bounce effect or other visual flourish. In some cases, sound effects or notifications may be sent, for example via a companion application as discussed above, or on software application 1002 on the host device.

In an example embodiment, the currently-active wireless jack devices may be analyzed and when a new “slot” opens up, the software application or other component may determine that a particular user is not present and provide a message querying whether than particular user would like to join the current track. For example, if in some occasions a user ID of “GeoffP” has played with other currently-active user IDs, the system may pop up a message asking if “GeoffP” would like to join. In some examples, a signal may be sent to the wireless jack device registered to “GeoffP” alerting him to this; e.g., a vibrate alert of other type of notification.

In another example, the wireless network condition may deteriorate, and while there may be 8 wireless jack devices on and present on the currently-active wireless network, the network can only handle five if the currently-chosen quality settings are to be maintained. In this instance, software application 1002 initially has 8 rows corresponding to the 8 wireless jack devices. An alert may be issued reflecting the fact that only five wireless jack devices can operate under the current conditions. For example, the bottom three rows may be shaded in a different color, or blink, or appear to vibrate on-screen. A type of “box” may be drawn around the top five rows and a visual prompt is provided prompting a user to drag-and-drop the five rows into it corresponding to the five wireless jack devices that will be participating in the recording. As the network capacity changes, or different recording parameters are chosen, the display may change in real-time to indicate visually that more or fewer slots have become available. In one embodiment, once a record command has been issued, no further changes to the composition of the wireless jack devices or recording quality may be processed, so any visual notifications are postponed until such time as changes can be made.

In another embodiment, when a surplus of “slots” are available, software application 1002 may connects to a third party online store where additional wireless jack devices may be purchased.

FIG. 10B is a flowchart showing an example process 1050 for providing user interface elements according to an embodiment. In some implementations, the process 1050 can include fewer, additional and/or different operations. In other examples, only one or some subset of these operations may be included, as each operation may stand alone, or may be provided in some different order other than that shown in FIG. 1050.

At 1052, the existence of all wireless jack devices present on the currently-active wireless network is determined.

At 1054, user interface elements (such as rows 1004 and 1006) are generated based upon the number of wireless jack devices present on the currently-active wireless network. In some embodiments, only wireless jack devices ready to transmit audio signals may be identified and user interface elements thereby generated.

At 1056, the wireless network status is monitored in real-time and this data, along with the requested audio quality settings, is analyzed to determine the capacity for wireless jack devices to be present and transmitting audio on the wireless network. In response to the analysis, user interface elements are generated (e.g., created, removed, altered) reflecting the current condition of the recording session.

### Using a Heartbeat Signal to Synchronize Wireless Audio Transmission

It should be understood that this section should be read in light of the preceding description, as the example approaches contained herein are closely related to those previously described.

Whenever multiple sources of audio are being recorded, it is necessary to synchronize the audio. This is exemplified by early techniques related to recording multiple tracks on multiple tape decks in a recording studio. Devices were devised to start the tape decks at the exact same moment, and the motors of each tape deck were individually controlled to keep each device in sync. For example, if one tape deck was running a little faster than another, the motor of one of the tape decks would be sped up or slowed down as needed.

When attempting to synchronize multiple audio signals going to multiple recording devices, previous approaches relied upon the fact that each device was connected to a central hub with a cable. By having a cable from each remote device to a hub, each remote device had its own private full-duplex communication channel. This allowed each device to “talk” to the hub at the same time. Also, each device was the only device talking on this particular channel (the cable connecting it to the hub), which eliminated the possibility of interference generated by another device. Further, there was no need to rely upon a standard communication protocol. If one so desired, a custom physical transport approach and protocol could be created that served a particular use case and/or equipment.

Example approaches described in the present application rely upon wireless jack devices that communicate audio signals over an existing wireless network to a software application executing on a central host device. Because all wireless jack devices must share a single communication path (the airwaves), there is no possibility for parallel messages (packets). Only one device may send a message at a time and all devices “hear” that message. Conventional networking approaches (e.g., WiFi specifications such as 802.11a/b/g/n) approach this issue by utilizing a collision/backoff/retry method. Collisions are detected by the failure of the message to be received. In response to a failure to send a message, the device “backs off” a random amount of time and then tries again, which may again result in failure, and the process is repeated until the message is delivered. As will be discussed, this approach creates an unacceptable amount of latency, especially when dealing with audio signals that must be synchronized within specific tolerances (in some cases as low as 5 milliseconds).

In addition, there may be other devices utilizing the wireless network over which no control and configuration data may be asserted (e.g., laptops, mobile devices, etc). This can create harmful interference and congestion of the wireless network, as could other devices which emit wireless signals, such as a microwave. Further, because standard wireless networking protocols are required in order to communicate on the wireless network, the possibility of customizing a communication protocol is foreclosed. The problem is not WiFi itself. For example, current approaches allow for the streaming of high-definition video over wireless networks, but one way of dealing with network congestion in that case is to modify or process the content stream; for example, buffer multiple seconds of video at the beginning so that a very large number of retries may be accommodated before the data is actually needed, or reduce the quality (and bandwidth required for the video) of video being streamed, for example from 720p to 480p.

In order for multiple wireless audio transmitting devices and a host device to operate as an aggregate system, their digital audio subsystems may be frequency locked. Digital audio is based on a process called uniform sampling, where the audio is periodically sampled and the resulting samples turned into digital data. The digital bits may then be transported, stored, or processed, for example, before being turned back into analog audio at some other point in the system. A prerequisite for such an approach is that a common sample rate must be observed at all points throughout the system. This becomes especially critical when there are multiple sources and destinations of audio in a system involving multiple users trying to communicate in real time.

Because of the nature of a real-time audio recording system as described by the approaches herein, it is not possible to process the content stream during a recording session in order to deal with network congestion or to achieve synchronization of multiple sources because such processing necessarily involves large store-and-forward buffers that unacceptably increase latency. Instead of inserting processing stages into the flow of content data, then, an example embodiment operates to synchronize the clocking layer prior to content data transmission. When this is done, much less content processing or buffering is necessary, and therefore latency is minimized. Therefore, techniques are described which allow for the synchronization of audio signals being wirelessly broadcast over a wireless network to a central hub from multiple individual devices.

Example approaches provide for a heartbeat timing signal to be sent from a device at a particular frequency and regular intervals in order to synchronize the remote wireless jack devices via wireless networking protocols for the purpose of creating each device's audio codec low jitter clock for maximum signal-to-noise ratio. The heartbeat signal in example embodiments also serves as a basis for a “WiFi Time Division Multiplexing (TDM)” approach, which is a transmission scheduling approach which results in packing the greatest number of channels into the finite bandwidth of the airwaves. If a device cannot sync to the heartbeat signal, that device may still participate if it is the source of the heartbeat signal. In some cases, this is the manner of selecting which device will generate the heartbeat signal. In an embodiment, the overall system is limited to one such heartbeat signal-generating device. In another embodiment, an alternate wireless jack device synchronization method can be used to serve as a reference for the PLL (for example, using timing data from the network protocol). In another embodiment, an alternate wireless jack device synchronization method involves the flow of packets (and the data contained within such packets) over the network where such packets themselves are used as a timing device to synchronize jack devices.

By using the example approaches described herein, all wireless jack devices present on the currently-active wireless network may transmit their audio signals to the host device without the latency created by current packet collision schemes. Digital devices have internal clock mechanisms driven by the physical properties of crystals. Because of this, no two devices may be considered identical. When multiple devices are working together, it is normal that one device may “talk” at 44,100 samples per second while another talks at 44,110 samples per second and another talks at 44,050 samples per second. This is not only because of the inherent physical differences between crystals, but could also be caused by factors such as heat and temperature variations, background processes, power fluctuations, and so forth. By trying to have multiple isolated devices digitizing audio and sending it to a central location, over time, the devices don't line up any more. Once a minute or two has elapsed, the devices begin to drift relative to each other. This creates numerous difficulties when dealing with multiple-source audio that must be near-perfectly synchronized.

According to an embodiment, the audio sample clocks of a number of remote devices (e.g., wireless jack devices) whose only means of communication is over a wireless network may be synchronized. In one example, a sample clock is created at all remote devices that is (a) synchronized to a common master clock and (b) smooth. Through this approach, there are no data over- or under-runs because the clocks are frequency-locked. Further, the clocks are smooth so that the digitized audio has an optimized signal-to-noise ratio. Also, the multiple sources have a basis for “taking turns” sharing the common wireless network channel, thereby avoiding WiFi's collision/backoff/retry mechanism in order to accommodate the greatest number of channels.

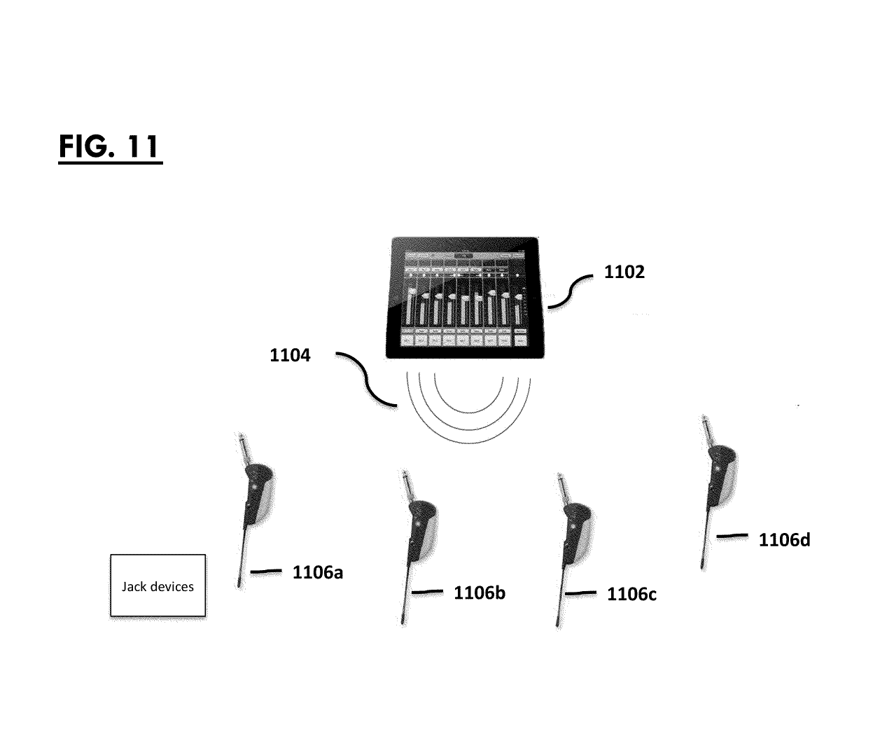

FIG. 11 is a depiction of an example environment for which the heartbeat synchronization embodiments may be utilized. In FIG. 11, a host device 1102, commonly executing a software application such as a recording/mixing/effects application as described earlier, is the destination for audio signals being transmitted over a wireless network 1104 from remote audio transmitting devices 1106a-1106d such as wireless jack devices. The wireless jack devices 1106a-1106d may be connected to instruments, microphones, MIDI devices and the like, as more fully described above. While host device 1102 is pictured as a tablet device, it is understood that host device 1102 could be (among other devices) a standard computing device with wireless capabilities and the ability to execute instructions (e.g., audio programs).

While the wireless jack devices 1106a-1106d send audio from its connected instrument/device to host device 1102, host device 1102 may subsequently broadcast data (such as a finished mix or mixes) to wireless jack devices 1106a-1106d via wireless network 1104 that would be received by wireless jack devices 1106a-1106d and provided, for example to a user via a headphone jack. While the discussion herein will focus on the transmission of audio signals to host device 1102, it is clear that using the techniques described herein to send signals in the reverse direction would be understood by one of ordinary skill in the art.

According to an embodiment, host device 1102 transmits a periodic signal (the “heartbeat”) over wireless network 1104, and the outlying wireless jack devices 1106a-1106d synchronize their audio sampling and transmission to this heartbeat. Example embodiments may determine various frequencies of this heartbeat message; for example, one heartbeat message every 8 audio sample periods. For a 48 kHz audio sample rate, this would result in a heartbeat frequency of 6 kHz, which may also be referred to herein as “(⅛)x.” Alternate embodiments envision different values for the heartbeat signal; however, for clarity, the following discussion will utilize 6 kHz ((⅛)x).

In example implementations, wireless jack devices 1106a-1106d comprise a Phase Locked Loop (PLL) module, as mentioned earlier and discussed herein. The wireless jack devices 1106a-1106d received the heartbeat from host device 1102 (or another wireless jack device) and the PLLs of wireless jack devices 1106a-1106d multiply the heartbeat frequency and smooth the result.

In this example, the PLL modules use the 6 kHz heartbeat to create a 12.288 MHz clock, which represents a 2,048x frequency multiplication as follows: (⅛)x*2,048=256x, where x is the 48 kHz sample rate. The resulting 256x clock is jitter-free to within ½ nanosecond in order to achieve acceptable signal-to-noise ratio of the transmitted audio. Therefore, in this example, the PLL module takes in 6 kHz and creates 12.288 MHz out. This is performed simultaneously on all remote transmitting devices. It should be understood that these values are for explanation only and example embodiments may comprise different values.

In example approaches, the heartbeat has only one constraint; i.e., that it has a constant and known average frequency, e.g., 6 kHz. The smoothness of this heartbeat broadcast could be corrupted at any point in the transmission; e.g., at the host device in the process of broadcasting the heartbeat, or at the wireless jack devices. These irregularities comprise jitter. When an audio waveform is digitized, the system requires uniform sampling; namely, that the timing between samples is always the same. Jitter is a departure from when those sample intervals are supposed to happen. Example embodiments comprise a jitter reduction approach in order to address these issues.

In an example approach, multiple stages are involved in smoothing the heartbeat signal. While the embodiments described within are envisioned as being implemented in a processing module 108 on a device printed circuit board (PCB), it is contemplated that such approaches could be implemented in software, hardware or a combination of both. One example implementation of smoothing the heartbeat signal follows.

In a first stage, the time between heartbeat pulses are measured, using in one example a local high-frequency crystal as the basis. For purposes of explanation, each of these measurements will be referred to as a “delta,” although other terms are envisioned and no limitation is intended from the selected nomenclature.

Next, these measured durations are averaged over a long-term interval. While no particular interval is required, in one embodiment the interval is the smallest interval that results in an unchanging integer value of the averaged result, where the fractional bits may change over time.

One approach to averaging these measured durations is to accumulate these time deltas as they appear but otherwise discard them. Then after, for example 1,024 time deltas have been accumulated, right-shift by 10 bits without discarding the fractional time that results (i.e., don't discard the bits that would otherwise shift off the end). This results in one averaged value per 1,024 heartbeats, with a 10-bit fraction for accuracy.

Another approach to averaging these measured durations is to create a moving window filter where the time deltas are accumulated but not discarded, instead keeping a record of the last 1,024 of them in a history buffer, which may be implemented in a manner known in the art. As each new delta comes in, the oldest one is selected out of the history buffer and subtracted from the accumulation, then discarded. This approach results in an average heartbeat period that is updated each time a new heartbeat arrives.

After determining a number representing the average measured period between heartbeat messages, where that number has been averaged over a long enough period that it is almost perfectly constant, the heartbeat frequency is multiplied by a factor of 2,048. This results in a square wave whose period is 1/2048 of the heartbeat period (i.e., that is 2,048 times faster than the heartbeat frequency). This will be done in two steps of 32x and 64x.

First, an example approach creates a square wave that is toggled at 64 times the rate of the calculated average, resulting in a 32x frequency multiplication from (⅛)x up to 4x. Any fractional bits are saved, and when they roll over in one direction or the other, the last square wave earlier or later is toggled by one tick. While this last operation creates jitter, this is addressed by next applying this 8x result to an analog PLL circuit that will create a clock that 64 times faster than its input, taking the 4x input up to 256x (12.288 MHz). This becomes master clock (MCLK) to the audio codec (CODEC).

Lastly, the processing module 108 in this example divides the 256x by four to yield the CODEC's bit clock, and by 256 to yield the CODEC's left/right (L/R) clock. The wireless jack devices apply these clocks to their CODECs, and send the generated audio samples that result back to the network logic module 112 to be sent over the air to the host device.

Another aspect of the present example implementations is to eliminate the collision/backoff/retry issues inherent to wireless networking transmission, as described earlier. This is required because the latency created by such a situation would frustrate the real-time audio transmission approaches described in this specification. Examples of this approach comprise the “WiFi Time Division Multiplexing (TDM)” approach mentioned earlier.

Because the clocks of the individual devices in the system have been synchronized via the example approaches described above, each sample period may be divided into a number of “time slots.” Each wireless jack device will have been assigned a unique time slot assignment, for example during the power-up discover phase, and this time slot assignment is used to determine exactly when, in the sample period, that the wireless jack device may transmit its audio data. As a result, each wireless jack device takes a turn broadcasting over the shared wireless network, which is done in an orderly manner that minimizes or eliminates the occurrence of WiFi collision/backoff/retry events.

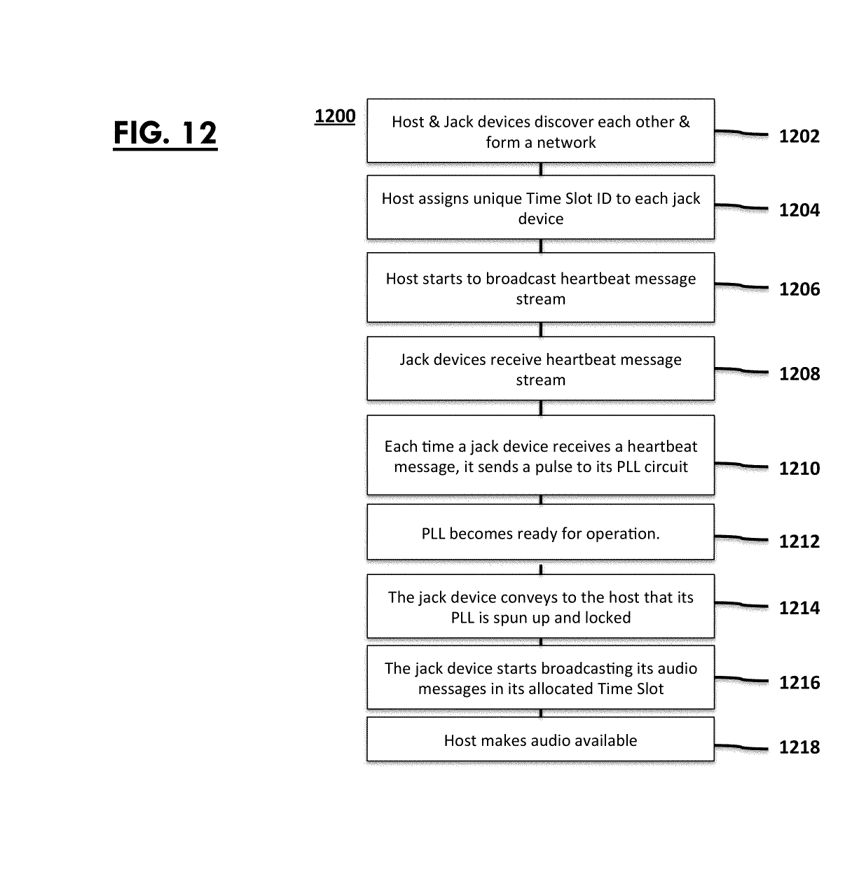

FIG. 12 is a flowchart showing an example process 1200 for synchronizing wireless audio data, according to an embodiment. In some implementations, the process 1200 can include fewer, additional and/or different operations. In other examples, only one or some subset of these operations may be included, as each operation may stand alone, or may be provided in some different order other than that shown in FIG. 12. While the functionality of the wireless audio driver interface may be described herein as being performed by a single entity, it is understood that other envisioned devices and modules, operating independently or concurrently, may perform the functionality described herein.

At 1202, the host device and wireless jack devices discover each other and create and join a wireless network as detailed previously herein.

At 1204, the host device assigns a unique time slot to each wireless jack device.

At 1206, the host device begins to broadcast a heartbeat message to the wireless jack devices over the wireless network.

At 1208, each time a wireless jack device receives a heartbeat message, it sends a pulse to its PLL module.

At 1210, the PLL module smoothes out the heartbeat signal to a particular frequency, as described above. In an example embodiment, a frequency that is 256 times the sample rate (relative to the heartbeat messages arriving at, say ⅛ the sample rate). At some point, the PLL module is considered synchronized to the incoming stream of heartbeat messages. A synchronized PLL is known as the “locked” state of the PLL.

At 1212, the wireless jack device communicates to the host device that its PLL module is locked and ready.

At 1214, the wireless jack device starts broadcasting its audio data in its allocated time slot.

At 1216, when the host device receives the “PLL locked” message from the wireless jack devices, the host device makes the received audio available, for example to software executing on the host device.

### Alternate Implementations

To implement some or all of the various technologies described above, components described in the present specification, such as the wireless jack devices, the wireless audio driver interface, the software application, the host device, or other systems not explicitly described herein may provide one or more application programming interfaces (APIs) or other interfacing logic or circuitry to allow the described components to communicate with the various systems described herein to facilitate those technologies.

While specific methods, tasks, operations, and data described herein are associated above with specific systems, other embodiments in which alternative apportionment of such tasks and data among the various systems are also possible. Further, while various systems, may be shown as separate entities in the Figures, one or more of these systems may be combined into one or more larger computing systems in other embodiments.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. While a client may comprise a server and vice versa, a client and server are generally remote from each other and typically interact through a communication network. The relationship of client and server arises by virtue of computer programs running on their respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set forth hardware (e.g., machine) and software architectures that may be deployed in various example embodiments.

Thus, methods and systems for generation and employment of wireless audio transmission have been described. Although the present subject matter has been described with reference to specific example embodiments, it will be evident that various modifications and changes may be made to these embodiments without departing from the broader scope of the subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels and are not intended to impose numerical requirements on their objects.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Hardware Mechanisms

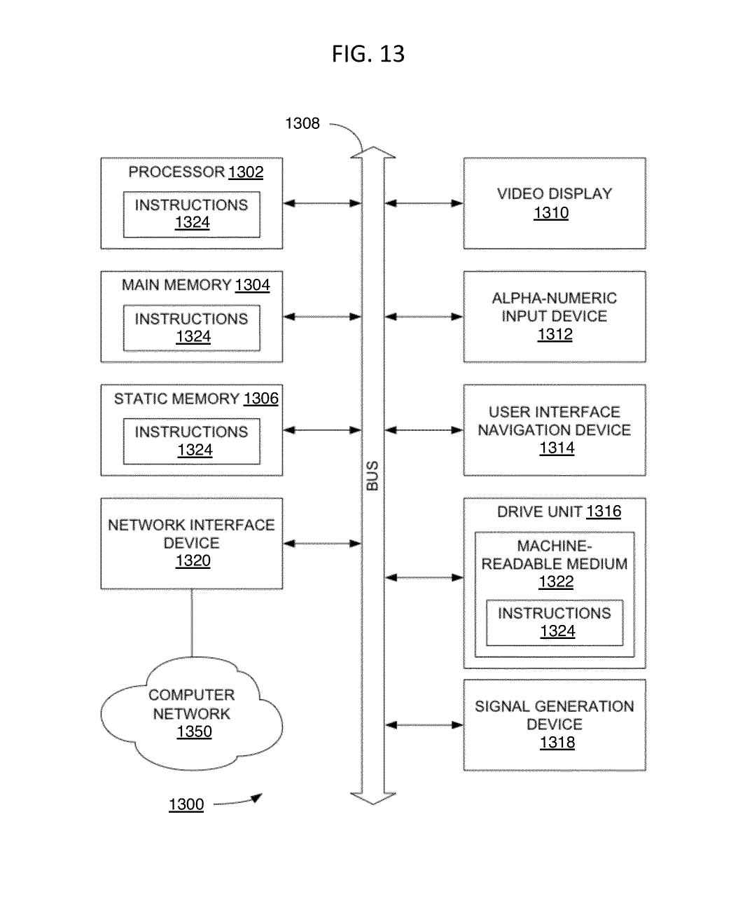

In an embodiment, elements of the techniques described herein may be implemented on, include, or correspond to a computer system. FIG. 13 is a block diagram of a machine in the example form of a computer system 1300 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device 1314 (e.g., a mouse), a disk drive unit 1316, a signal generation device 1318 (e.g., a speaker), and a network interface device 1320.

The disk drive unit 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions 1324 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 1324 may further be transmitted or received over a computer network 1350 using a transmission medium. The instructions 1324 may be transmitted using the network interface device 1320 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

In the foregoing specification, example embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for transmitting wireless audio, comprising:
receiving audio signals generated by a plurality of sources at a plurality of audio transceiver devices each communicatively coupled to a single source, wherein the audio transceiver devices have wireless transmission capabilities for sending and/or receiving the audio signals over a wireless connection;
causing the audio transceiver devices to connect to a wireless network, wherein the creation of the wireless network is initiated by at least one of the audio transceiver devices;
transmitting the audio signals from the audio transceiver devices over the wireless network to a host device, wherein the host device is connected to the wireless network.

2. The method of claim 1, wherein the wireless network conforms to wireless standard networking protocols.

3. The method of claim 1, wherein the audio transceiver devices store configuration data relating to a default wireless network.

4. The method of claim 1, wherein the creation of the wireless network is initiated by the host device.

5. The method of claim 1, further comprising the host device executing a software application operable to combine the audio signals from each audio transceiver device into a multi-track recording.

6. The method of claim 1, further comprising the host device executing a software application operable to combine the audio signals from each audio transceiver device and transmit the resulting audio signal over the wireless network.

7. The method of claim 6, wherein the software application applies effects processing to the audio signal prior to transmitting the audio signal over the wireless network.

8. The method of claim 1, wherein the audio transceiver devices are configured to transmit the audio signals simultaneously over the wireless network and a wired connection.

9. The method of claim 1, wherein the host device executes a software application configured to issue a command that disconnects one or more of the audio transceiver devices from the wireless network.

10. The method of claim 1, further comprising:
receiving video signals at the host device, wherein the video signals comprise real-time video of the performance generating the audio signals;
the host device executing a software application operable to synchronize the video signals with the audio signals, combine the video and audio signals, and transmit the combined signal to an external device.

11. A system for transmitting audio signals over a wireless connection, comprising:
at least one audio transceiver device configured to receive audio signals from a source;
a host device configured to receive audio signal data from the at least one audio transceiver device;
a wireless network, wherein the audio transceiver device and the host device have wireless transmission capabilities for sending and/or receiving audio signals over a wireless connection;
wherein the wireless network is initiated by the at least one audio transceiver device.

12. The system of claim 11, wherein the at least one audio transceiver device is configured to store configuration data relating to a default wireless network.

13. The system of claim 11, further comprising a software application executing on the host device and operable to combine the audio signals from a plurality of audio transceiver devices into a multi-track recording.

14. The system of claim 11, further comprising a software application executing on the host device and operable to combine audio signals from a plurality of sources transmitted from a plurality of transceiver devices and transmit the resulting audio signal over the wireless network.

15. The system of claim 14, wherein the software application is operable to apply effects processing to the audio signal prior to transmitting the audio signal over the wireless network.

16. A device for transmitting audio signals over a wireless connection, comprising:
an input module for receiving audio signals from a source to which the device is communicatively coupled;
a networking module for creating a wireless network and for receiving and transmitting audio signals over the wireless network;
a processing module for executing one or more sequences of instructions stored in a memory module, the instructions which when executed by the processing module, causes:
accessing configuration data describing parameters of a default wireless network;
creating and joining a wireless network based on the parameters described by the configuration data;
in response to receiving instructions from a host device, receiving the audio signals from the source and transmitting the audio signals over the wireless network to the host device.

17. The device of claim 16, further comprising:
in response to receiving instructions from the host device, disconnecting from the wireless network.

18. The device of claim 16, wherein the device is attached to a microphone such that the device is flush with the microphone chassis.

19. The device of claim 16, further comprising an output module capable of transmitting audio signals to an external device at the same time the networking module is transmitting the audio signals wirelessly.

20. The device of claim 16, further comprising an audio processing module configured to apply effects processing to the audio signals.
